(19) United States
(12) Patent Application Publication
(10) Pub. No.: US 2018/0218343 A1
(43) Pub. Date: Aug. 2, 2018

(54) SMART CONTRACT EXECUTION ON A BLOCKCHAIN

(71) Applicant: Dais Technology, Inc., Glenview, IL (US)

(72) Inventors: Jason Kolb, Glenview, IL (US); Aaron Larson, Ankeny, IA (US)

(21) Appl. No.: 15/884,111

(22) Filed: Jan. 30, 2018

Related U.S. Application Data
(60) Provisional application No. 62/452,173, filed on Jan. 30, 2017.

(51) Int. Cl. G06Q 20/10; G06Q 20/40; H04L 9/06

(52) U.S. Cl. CPC G06Q 20/102; H04L 67/104; H04L 9/0637; G06Q 20/405

(57) ABSTRACT

An automated interconnection system for executing a smart contract in a blockchain is provided. A payout notification is generated either a notification to the smart contract of a behavior event or the smart contract periodically scanning for a payout request. Behavior data is retrieved from the blockchain and a payout validity is determined based on logic of the smart contract. If a payout is valid, a payout amount is calculated and a payout is made from a payout fund. If a payout is not valid, payout funds are returned to the creator of the smart contract if the smart contract does not allow for retrying the payout process, or the payout funds are held pending retrying the payout process. Methods and computer readable media are also provided.

### CROSS-REFERENCE TO RELATED APPLICATIONS

This application claims the benefit of U.S. Provisional Patent Application No. 62/452,173, filed Jan. 30, 2017, which is expressly incorporated herein by reference and made a part hereof.

### TECHNICAL FIELD

The present disclosure generally relates to a smart contract, and more specifically relates to executing a smart contract on a blockchain.

### BACKGROUND

The corporate world, including the insurance industry, is fundamentally disconnected today. For example, with respect to the insurance industry, agents, brokers, carriers, and capital providers (e.g., reinsurers, private equity, hedge funds, etc.) do not run systems that speak a common language. This results in workflows that are driven by paper, email, fax, and a number of other channels, each having a common bottleneck that in a disconnected workflow human middlemen are required to facilitate each process. Thus, slower, less efficient and more expensive outcomes are experienced by everyone involved, including the policyholders.

It is desired to provide a system for connectivity to the participants that touches and changes every aspect of the insurance lifecycle, makes risk transparent and granular, and creates incentives that spur cooperation, collaboration, and innovation for mutual benefit.

The description provided in the background section should not be assumed to be prior art merely because it is mentioned in or associated with the background section. The background section may include information that describes one or more aspects of the subject technology.

### SUMMARY

According to certain aspects of the present disclosure, a computer-implemented method for executing a smart contract in a blockchain is provided. In one or more embodiments, the method includes receiving, by one or more processors, a payout notification, wherein the payout notification is generated by one of a notification to the smart contract of a behavior event and the smart contract periodically scanning for a payout request; retrieving, by one or more processors, behavior data from the blockchain; and determining, by one or more processors, if a payout is valid based on smart contract logic. If the payout is valid, the method includes calculating, by one or more processors, a payout amount and generating, by one or more processors, a payout from a payout fund. If the payout is not valid, the method includes returning payout funds to a creator of the smart contract if the smart contract does not allow for retrying the payout process and holding the payout funds if the smart contract allows for retrying the payout process. In one embodiment, the processors are virtual machines that run code written to the blockchain.

According to certain aspects of the present disclosure, a smart contract system is provided. The system includes a memory and a processor configured to execute instructions. The executed instructions cause the processor to scan the system periodically, by a smart contract, for a payout request; receive a payout notification; retrieve behavior data from a blockchain; and determine if a payout is valid based on smart contract logic. If the payout is valid, the executed instructions cause the processor to calculate a payout amount and generate a payout from a payout fund. If the payout is not valid, the executed instructions cause the processor to return payout funds to a creator of the smart contract if the smart contract does not allow for retrying the payout process and hold the payout funds if the smart contract allows for retrying the payout process.

According to certain aspects of the present disclosure, a non-transitory machine-readable storage medium comprising machine-readable instructions for causing a processor to execute a method for executing a smart contract in a blockchain is provided. The method includes scanning periodically, by the smart contract in the blockchain, for a payout request; receiving a payout notification based on the payout request; retrieving, by one or more processors, behavior data from the blockchain; and determining, by one or more processors, if a payout is valid based on smart contract logic. If the payout is valid, the method also includes calculating, by one or more processors, a payout amount and generating, by one or more processors, a payout from a payout fund. If the payout is not valid, the method also includes returning payout funds to a creator of the smart contract if the smart contract does not allow for retrying the payout process and holding the payout funds if the smart contract allows for retrying the payout process.

It is understood that other configurations of the subject technology will become readily apparent to those skilled in the art from the following detailed description, wherein various configurations of the subject technology are shown and described by way of illustration. As will be realized, the subject technology is capable of other and different configurations, and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates an example architecture for providing an automated interconnection system.

FIG. 2 is a block diagram illustrating an example client and server from the architecture of FIG. 1 according to certain aspects of the disclosure.

FIG. 3 illustrates a traditional interconnection of participants in an insurance network.

FIG. 4 illustrates interconnection of participants in an embodiment of an interconnection system.

FIG. 5 illustrates interconnection of core services in an embodiment of an interconnection system.

FIG. 6 illustrates a unit of risk schema provided by an embodiment of an interconnection system.

FIG. 7A illustrates a covered peril schema in a traditional system.

FIG. 7B illustrates a covered peril schema provided by an embodiment of an interconnection system.

FIG. 8 illustrates an interconnection tool schema provided by an embodiment of an interconnection system.

FIG. 9 illustrates a risk navigation schema provided by an embodiment of an interconnection system.

FIG. 10 illustrates an agency workflow schema provided by an embodiment of an interconnection system.

FIG. 11 illustrates an on-demand risk securitization workflow schema provided by an embodiment of an interconnection system.

FIG. 12 is an example process associated with the disclosure of FIG. 2.

FIG. 13 is an example process associated with the disclosure of FIG. 2.

FIG. 14 is an example process associated with the disclosure of FIG. 2.

FIG. 15 is an example process associated with the disclosure of FIG. 2.

FIG. 16 is a block diagram illustrating an example computer system with which the clients and server of FIG. 2 can be implemented.

FIG. 17 is an example process associated with the disclosure of FIG. 2.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive.

### General Overview

In the conventional insurance world, there are several core systems that provide the capabilities needed to facilitate the risk to coverage process. These traditional core systems are applicable to particular participants in the insurance environment. Carrier core systems are utilized by insurance carriers that provide the insurance products and have several parts, including policy issuance, servicing and risk improvement. Here, policy issuance involves processing insurance applications and intake, eligibility requirements and underwriting. Similarly, servicing involves processes related to claims, such as intake, adjusting, disbursement and reserve forecasting. Servicing also includes processes related to billing and payments.

On the other hand, agency core systems are utilized by the agencies that provide the interface between the carriers and the policyholder population. Agency core systems are also categorized into several parts, such as sales, accounting and billing, incentive structuring and commission structure, and activity reporting and key metrics. Here, sales involve prospecting, appetite matching, intake and quoting.

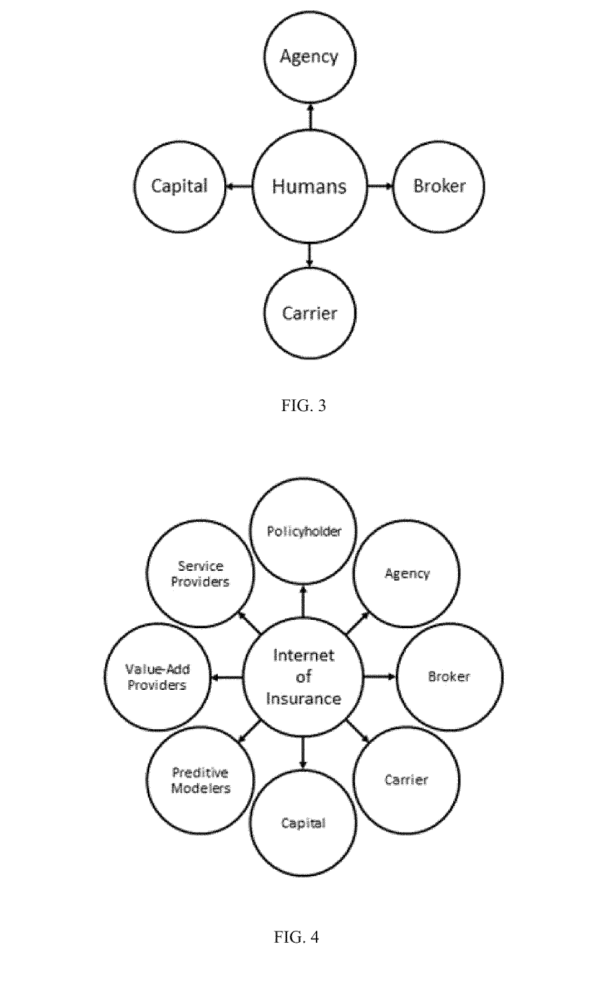

However, these core systems are typically provided by a variety of disconnected proprietary systems that vary between and even within participants. For example, carriers may have many core systems having different architectures, languages and protocols within each carrier's own organization and that further vary substantially between different carriers. Thus, as shown in FIG. 3, human intermediaries are required to facilitate information and tasks between carriers, agencies, brokers, and capital providers.

The subject technology (e.g., system) provides a network that replaces the human intermediary with an automated system that connects all of the participants at a fundamental level. It provides a standard vocabulary (protocol), a trusted common data store where every participant can see the same data, and facilities for navigating risk. This common shared system replaces human bottlenecks with scalable, trusted, and transparent systems.

Thus, the system provides a radical departure from the way insurance is handled today. It provides connectivity to the insurance world that touches and changes every aspect of the insurance lifecycle. It also makes risk transparent and granular, which improves efficiency and maximizes profits for each participant in the ecosystem. Further, it provides for shaping behaviors of system participants by creating incentives which spur cooperation, collaboration, and innovation for mutual benefit. For example, by publishing success data to a blockchain, the system provides a completely new business model for agents, value-add providers, and policyholders, such as incentivizing any participant having the ability to influence an outcome based on success. The system also allows participants to take on roles and activities that have historically belong to other ecosystem members. For example, an agency can take on underwriting responsibilities to become an MGA (Managing General Agency).

Further, the insurance industry currently has every participant investing lots of money in their own proprietary and disconnected systems. By moving shared systems into the subject system and building them on a common blockchain, participants are incentivized to help upgrade the system network over time. For example, a protocol layer of the system is made up of smart contracts that live on a blockchain. By properly aligning incentives, the system is resilient to any one participant skewing the system in their favor. Also, the system itself votes on upgrades, so the system may be upgraded to deal with any unforeseen consequences. Thus, the protocol at the heart of the system provides a common language that all participants can use and improve together.

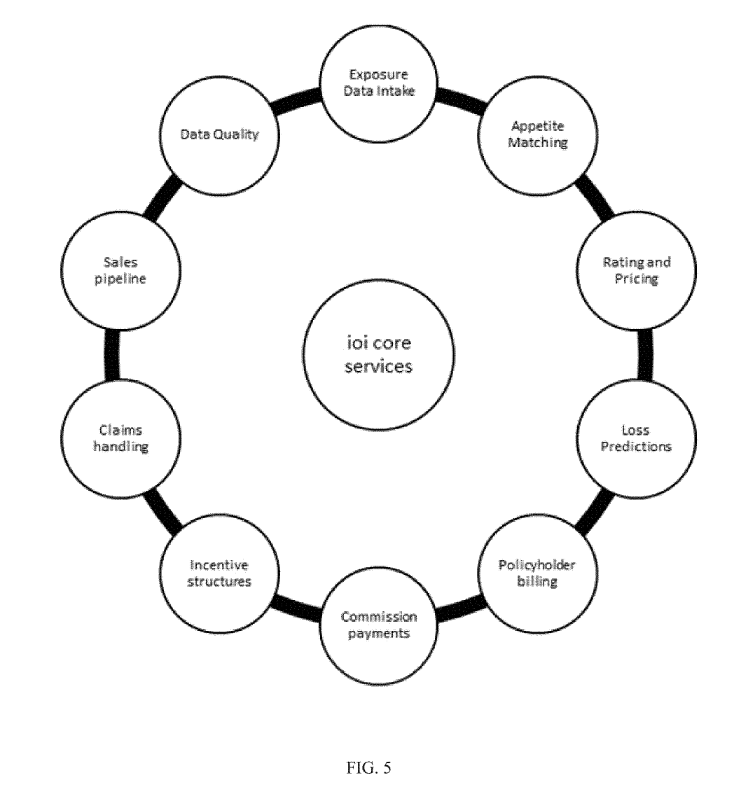

Thus, as shown in FIG. 4, the subject technology not only provides an automated system interconnecting the traditional carriers, agencies, brokers, and capital providers, but further interconnects additional participants through the automated system, such as policyholders, service providers, value-add providers and predictive modelers. For example, the addition of policyholders allows the system to build a digital record of policyholder assets and resources (e.g., customers, equipment, vehicles, and inventory). The system may also determine or document policyholder behavior (e.g., how the assets are used and maintained, where the assets are being used, what types of jobs the assets are being used for, etc.).

The system may provide predictive modelers the conduit and/or tools for making predictions against anonymous data, creating a track record of accuracy, and monetizing the modeler's capabilities. Startups and value-add providers may also bring value to the network through the system and be compensated for that value. The system may also provide for service providers (e.g., inspectors and adjustors) to be paid for specific pieces of work, and to be compensated in a variety of ways (e.g., on success).

Here, all of the system participants may be aligned in ensuring that a policyholder has the right coverages, becomes safer over time, grows, and has a great customer experience. The system also removes technology constraints so that each participant of the system is freed to do what the participant does best. For example, brokers may provide sales assistance, deep industry knowledge, and specialized underwriting facilities to the network of participants; carriers may focus on selecting and pricing risk; and, agents may focus on finding risk and selling coverage.

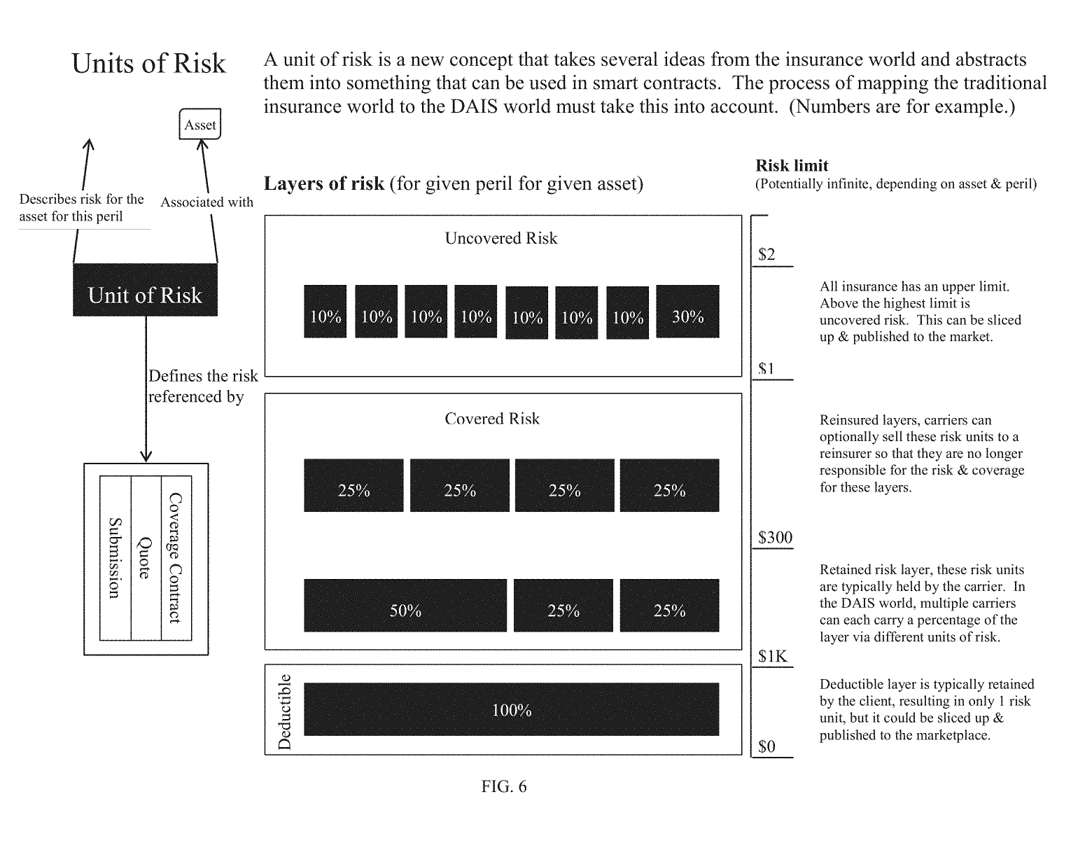

As shown in FIG. 5, the system interconnects all of the core services, thereby making each core service available to all participants in the system. Such interconnection of the core services may provide many outcomes. For example, all participants have access to the same core systems, yet each participant is free to provide core services to the market under its own brand. There may also be new shared core system which benefit from the network (e.g., data quality). Tasks and responsibilities may be moved around the network (e.g., an agent may initiate and monitor claims on behalf of a policyholder or handle all billing and payments for a customer). Agencies and carriers may share elements of each party's pipeline with one another. For example, an agent may see how a carrier is progressing on a quote and a carrier may see how an agent is progressing on closing a policy that has been quoted. Carriers may use more sophisticated sales reporting capabilities usually only used by sophisticated agents (e.g., hit ratio, impact of value-adds on conversion).

Because all participants have access to the same core systems, new participants can join the network and add enhanced capabilities. For example, independent adjusters, including those based on emerging technology such as drones, may participate on-demand. Independent modelers may make verified predictions about loss events, which may be used in pricing models. Data providers may provide new streams of exposure data, which may be factored into models. Startups and other companies may offer value-added tools that may be subsidized for the benefit of the policyholder and provide exposure data. Policyholders may make commitments about their behavior, which can be tied to smart insurance policies.

In the traditional insurance system, insurance coverage is handled in chunks. For example, agencies sell packaged policies to carriers, carriers sign contracts with reinsurers to cover layers of risk within the carriers books, and if a book of business is moved by an agency from one carrier to another (e.g., book roll), it is typically done in one transaction. This frictional and processing-intensive nature of handling coverage in chunks using people has many drawbacks.

For example, agencies are forced to limit the number of carriers who have access to risk because of the time and expense in submitting coverage to each carrier, carriers are forced to write undesirable coverage to facilitate a package policy, and agencies are forced to take lower commission on policies that have more demand outside of a package policy. In addition, book rolls result in a carrier taking on risk that doesn't fit its investment or diversification strategies, and the carrier may end up dropping the policyholder anyway. If capital providers such as private equity or hedge funds want to invest in risk coverage, the capital providers are forced to invest indirectly through carriers or reinsurers. Also, reinsurers are not sure of their exposure as they have no way to see coverage down to the policy level and the number of carriers that can participate in offered risk is constrained because of the human effort involved.

The subject technology removes the dependency on handling coverage in chunks, thereby breaking down risk into more fundamental risk units that represent the underlying risk behind a policy. For example, the system provides for agencies, as the agencies source risk, to effectively securitize the risk and offer it to a wide universe of capital with more pricing capacity.

Another hallmark of the traditional insurance system is that activity is opaque across the participants of the system, resulting in many inefficiencies. For example, agencies do not always know when a policyholder has a claim; policyholders do not know the status of their claims or who is working on them; agencies do not know how safe their clients are on an individual basis; capital providers bearing risk do not know exactly what risk is being covered or even who the policyholders are that are covered; policyholders are not able to share any work they have done to improve their risk profile with their agent or carrier; agencies and carriers are not able to jump in and help when policyholders have a risk-related issue; and agencies are not able to easily tell which coverages are relevant to a given client or which coverages the market offers that the client might be interested in.

By contrast, because the subject technology connects all of the participants in a common network, it becomes very easy to share all of this information across the network, down to the unit of risk. Thus, by adding in new network participants and data flowing between, new forms of information become available. For example, efficacy of loss improvement programs and value-added tools in reducing risk may be obtained by observing policyholder adherence and usage combined with the frequency of loss events. As another example, a carrier may be able to see how its pricing and forecasting compare to the industry (e.g., where it is overpricing or underpricing, why it is losing out to competitors, the impact of value-adds to conversion success). A further benefit is that trust is unquestioned because claims, payments, safety, outcome improvements, and what is covered are transparent to all participants.

Because risk is chunky and opaque in the tradition insurance system, risk is very difficult to transfer. It is still done, but it is very paper-driven, frictional, and expensive. For example, risk transfer typically occurs in the traditional system when a carrier acquires another carrier, an agency acquires another agency, and an agency moves a book of business from one carrier to another.

The subject technology provides a unit of risk to facilitate micro acquisitions in order to replace the traditional large and chunky transactions with precise risk acquisition. The unit of risk feature provides for new interactions between participants. For example, agencies may buy portions of books from other agencies rather than the entire company. As another example, as risk is moved from one carrier to another the prior-year liabilities do not move with it, making micro-acquisitions much more profitable than carrier acquisitions. In addition, agencies may be able to identify acquisition targets through visibility into books of business if given permission.

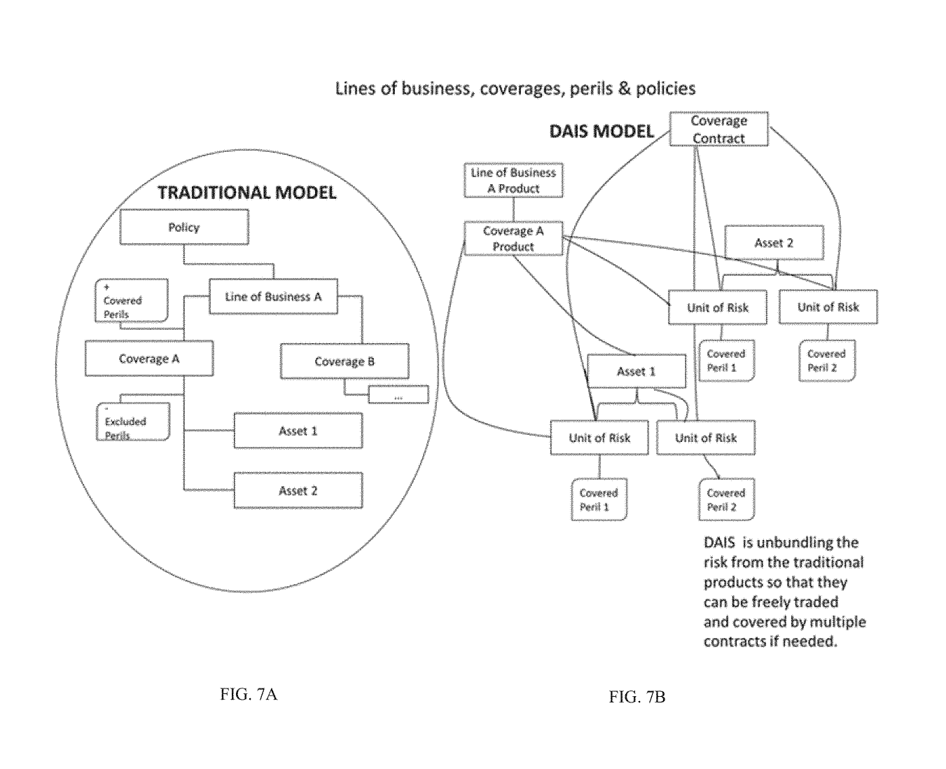

A unit of risk may be represented as data on a blockchain. A unit of risk represents a quantified and bounded piece of risk, and is the smallest level against which coverage may be sold. Fundamentally, a unit of risk breaks an entire risk associated with an asset down to a series of layers of risk for a given peril, and further to blocks of percentages within those layers, as shown in FIG. 6. The upper and lower bounds of the layer are defined as the upper bound of a claim limit and the lower bound of a claim limit, respectively. Within a layer, a risk unit will cover a given percentage of that layer of risk, from 0-100%. A risk unit may not cover more than 100% of a risk layer. A risk will also typically be time-bounded, either by the effective date and expiration date of a traditional policy or the start and stop time for real-time or on-demand coverage.

In the example shown in FIG. 6, the policyholder owns the risk units in the deductible layer. The carrier may own the next three risk layers, from $1K to $1M. However, the carrier may sell off the risk units in the top layer to different reinsurers to cap its risk.

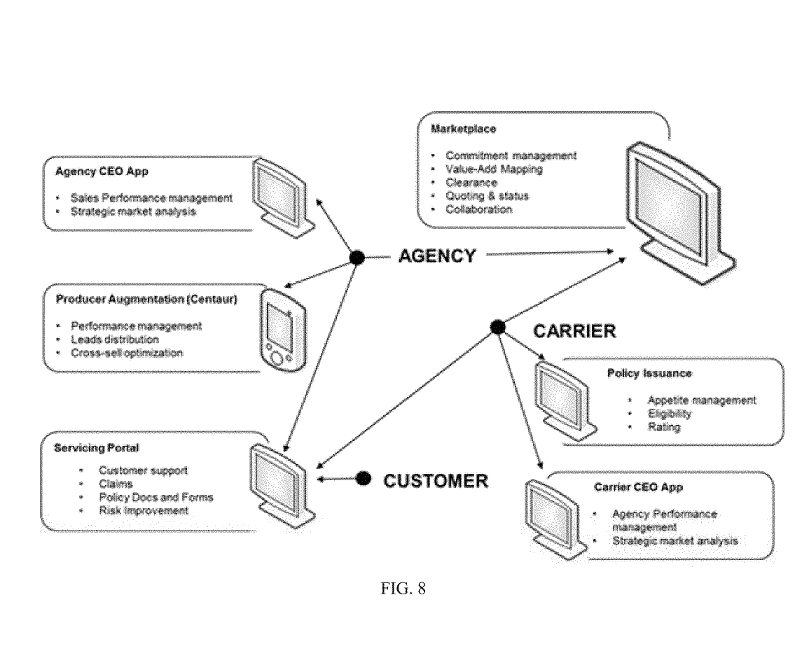

A unit of risk may have several attributes, such as a unique identification name, number and/or address to identify the risk across the marketplace and asset identification (e.g., potentially pointing to one or more asset's unique identification ID on an asset blockchain to capture the relationship). Another attribute is the type of peril, which depends on the type of the asset. The peril may include (for different asset types), property, liability, loss of business, asset spoilage, poor health, injury, death, diminished earning potential. FIG. 7 illustrates how perils may be treated in the traditional insurance system and the subject system.

Exposure data is another unit of risk attribute that can be collected automatically using software tools, brought in from external data sources, or manually input by the coverage buyer, their agent or broker, or an underwriter. Exposure links an asset's attributes to a measure of risk. Exposure data may be published to a blockchain in full or anonymized fashion, and pointed to by the unit of risk to define the relationship.

Other attributes include claim history for the asset and the asset owner (e.g., using claim identification numbers pointing to a blockchain to capture the relationship), payment history for the asset owner (e.g., using payment agreement identification numbers pointing to a payment blockchain to capture the relationship), and the layer of risk, including the upper and lower bounds of exposure (e.g., $10,000 to $100,000). Further unit of risk attributes include the start time and end time (e.g., primarily for on-demand coverage), reinstated layer of risk (e.g., additional $10,000 reinstatement layer if a first event occurs), and the percentage of the risk layer (e.g., 35%). Another attribute is a coverage base that defines the scope of coverage being sought. For example, a duration defined in terms of absolute dates and times or a length of time. Another example of a coverage base is a mission. A mission is a defined project with defined starting and ending points and objectives, using mission identifiers published to a mission blockchain to define the relationship.

The risk associated with an asset or a person and is initially owned by the asset owner, but can be quantified as units of risk and covered by insurance coverage bought in the marketplace. Coverage on a risk unit is an asset to the coverage seller and can be transferred, providing the contract describing the policy allows it. For example, using layer nomenclature from the traditional insurance world, a carrier's terminology “a $500 deductible with a $1 million limit” would imply a risk unit with a lower bound of $500 and an upper bound of $lmillion, with 100% of the layer covered. At the reinsurer layer, the same amount of risk would be described as a “$lmillion layer.”

Another fundamental change from the subject technology is the ability to shape behaviors by creating incentive structures that are incorporated into the network itself. This is used to help smooth some fundamental misalignments in the industry so that every participant can move fast and execute on what the participant is great at. Units of risk may be associated with perils on a one-to-one basis, where a peril is a specific type of risk related to a property.

With regard to policyholders, the subject technology may drive providing visibility to operations, providing new streams of exposure data, adoption and utilization of value-added tools, and adherence to commitments made to agents and carriers. From an agent perspective, the system may drive identifying risk and publishing it for quoting, helping policyholders select the best coverage, presenting relevant solutions that will help the policyholder, subsidizing value-adds for policyholders and carriers, and helping policyholders drive adoption and utilization of value-added tools. Carriers may be driven to quoting as much risk as possible and subsidizing value-adds for policyholders and agents. Similarly, brokers may be driven to providing specialized underwriting facilities and providing sales support as needed, including on-demand.

For reinsurance and other capital providers, the drivers may include providing a market for commodity risk, providing a market for risk that the carrier market does not want, and subsidizing value-adds for policyholders, carriers, and agents. Startups and other companies may be driven to making policyholders safer, while data providers may prove data that is useful to one of the other participants as the participant works on accomplishing its goals and providing accurate data. Further, all of these behaviors by all of the participants may drive usage of the system.

These incentives may not be equally valuable, and therefore the system provides for the incentives to be compensated accordingly. Also, these incentives may exist on top of the traditional incentive layer that is centered around making sure coverage is adequate for the risk, thus providing for all participants to be profitable.

A cryptocurrency may be provided by the system to be used as a reward and as the fuel that powers the core network system and protocol. Here, incentives are built into smart contracts in a protocol layer and are therefore only changeable with the consent of the network system itself (e.g., the insurance ecosystem). Further, incentives may be paid out in riskcoin units, which represent ownership in the network system, so every participant has an incentive to drive usage by all participants, including competitors. Because the value of the network system goes up with adoption, each existing member of the network system benefits monetarily as new members join. For example, the value of a participant's riskcoin goes up per Metcalfe's Law.

Another issue with the traditional insurance system is a lack of a trusted history that can be shared among participants. For example, with regard to data purchasing, because carriers cannot trust that data has not been tampered with, every carrier ends up purchasing its own copy of the underlying exposure data. The subject technology provides for moving data that must be trusted to a blockchain, thus remove inefficiencies, simplifying the supply chain, and incentivizing everyone to use the system network.

The trusted shared history provided by the system further provides for adding public commitments to an insurance policy. Public commitments can be made by any participant in the system. For example, agents can commit to present a quote, agents and carriers can commit to subsidize a value-add for a policyholder, and policyholders can commit to behaviors (e.g., putting all employees through best-practice training). As another example, the system provides for a policyholder to make a commitment (e.g., behavioral commitment) around the policyholder's behavior and a smart policy that evaluates and reacts to that policyholder behavior.

Regarding public commitments, commitment agreements are linked live in the system by smart contracts and these commitment agreements may be published to a blockchain and evaluated by the system. For example, participation in wellness programs, achieved and measured outcomes (e.g., weight loss and/or improved blood test results), training implementation, certification and risk improvement activities may be tracked. Here, a term or condition is something that must be agreed to, which translates to something that must evaluate as true or false in order for the contract to be valid (e.g., “The policy holder must pass a nicotine test” and “The business must be in good standing with the state”). These conditions may take many forms depending on the programming language being used. These conditions may also be stored on a blockchain as structured data that can be created and evaluated in a standardized way. Thus, the conditions may be expressed by coverage sellers, understood by the system and shown to coverage buyers in plain language, and then embedded in the resulting smart contracts that signify the terms of a transaction.

Any asset has associated risk and liability, from bodies to vehicles. In the subject system, this risk is provided in a unit of risk framework. A unit of risk is effectively a portion of the risk being covered by a policy. Thus, the risk may be transferred between parties much more easily. For example, a carrier may transfer units of risk to a reinsurer to mitigate the carrier's exposure to a specific risk.

Though many aspects of the subject technology are configured to be hosted in a public, open blockchain, some aspects may be configured for use in a closed or proprietary platform. For example, some data is not useful or appropriate for consumption by the wider network and may be held as a competitive advantage for participants. In this case, the system may keep the following data back as private and not on the blockchain. Market definitions, product definitions, bids and asks, sensitive data, rich identities and streams of exposure data are some types of information that may be kept proprietary and not published to the blockchain. For example, streams of exposure data may include identifiable information such as location. For this reason, a participant may host the raw data for the data provider, or the data provider may host it themselves. Here, only when the exposure data results in an exposure event will the exposure event itself be published to the blockchain. From there it may be associated with claims, payment, and other facilities of the network for consumption and use by smart contracts.

Canonical definitions of certain types of entities and events are shared across many different elements of the blockchain and so should also live on the blockchain. Following are many aspects that are provided by the subject system for use on a public blockchain.

Asset types define the classes of assets available to be bought, sold, or covered (e.g., car, property, and factory). Asset types may include an income stream (e.g., in product recall insurance), availability and quality of supply chain materials (e.g., in supply chain insurance), an individual's body, jewelry, semi-finished jewels, data, currency, digital currency (e.g., bitcoin), a unit of risk, intellectual property, equity ownership in a business, bicycles, vehicles, collectibles, antiques, construction equipment, transportation equipment, buildings, personal electronics (e.g., mobile phone), office equipment, computer equipment, legal contracts, ventures (e.g., films, construction projects), inventory, watches, clothing, customer accounts and contracts, real estate and other items of value.

Perils are the different types of bad things that can happen to an asset. A peril is a specific type of event that is being protected against for the asset associated with the unit of risk. Some examples of perils are, auto perils (e.g., fire, collision), property perils (e.g., fire, shoddy engineering, flood, hurricane), food shipment perils (e.g., asset spoilage, theft) and bodily injury perils (e.g., skydiving, kidnapping, disability). A risk unit is associated with a single peril, however multiple risk units may be created for the same asset, including for different perils.

Resource types are typically used in an “agent of record” contract to define what an agent is authorized to represent. Resource types can be attached to agency of record agreements. Example resource types may be risk and liability, real estate and cars.

Behaviors are also provided by the system. Here, the system may enumerate behaviors and identify the related exposure data event type that would indicate this behavior has occurred. A behavior can either be a lack of this event type (e.g., speeding violation) or the presence of this event type (e.g., training course completed).

Identities may be proven using a public and/or private key. Identities are proven by the owner of the identity using the owner's private key to sign transactions in which the identity participates.

Assets include items that can be owned as well as used. Assets can be related to people and organizations not just through ownership, but also through alternative relationships such as rental agreements. Ownership may be traced by token ownership and “right to use” may be represented by not just a token, but also an associated smart contract.

Data providers are system members who have access to unique data that is useful to other members of the ecosystem. Such unique data may be public or proprietary, and may be made available to other participants for a number of reasons. For example, carriers may use provided unique data to price a policy quote, agents may use provided unique data to help sell a policy, and carriers may include conditions and commitments in their smart policies that react to changes in data (e.g., a policy's monthly price could go up if a restaurant receives a health code violation). Data may be provided for free or on a paid basis in the system network. The system also provides for managing data licensing, payment tracking and processing for data providers.

Asset owners are typically the ones using the asset for something productive, like plowing a road or wearing it on their finger (e.g., jewelry). The owner of the asset, by default, owns all of the risk and liability associated with the owned asset. Asset owners are often interested in buying risk coverage (e.g., insurance) so that the asset owner is not responsible for all of the risk and liability associated with the asset. For example, an asset owner might want to offload some of the risk of damage to a mailbox, a break-down of equipment or vehicles, non-fulfillment of a contract, or loss of an earring. Thus, goals of the asset owner may be to reduce risk, reduce liability, gain maximum utility from the asset, swap the asset for another if economically feasible, grow business or improve profitability using the asset.

A coverage seller is traditionally either an insurance company (e.g., carrier) or a reinsurer that sells coverage to insurers. A coverage seller is selling coverage against targeted risk as determined by its investment strategies. A coverage seller's goals may be to describe an investment strategy in the form of a described appetite, automate as much of the investment execution as possible, obtain the most premium for the least amount of loss, and curate a strong reputation in the marketplace as a coverage seller who is easy to do business with (e.g., pays claims promptly, is financially stable). Thus, insurers effectively become investment portfolio managers, selling coverage into the marketplace at prices and exposures determined by their individual investment and risk-bearing strategies. The subject technology provides for the insurer to transfer coverage and risk to another coverage seller in a much more liquid way. The system may also provide for investment banks and private equity companies to be able to view risk and sell coverage against it, thus opening up an entirely new class of investment vehicles to the capital markets.

Agents and brokers have relationships with asset owners and act on their behalf to purchase risk coverage, and sometimes even assets such as risk units. Agents and brokers may hide the complexities of the marketplace from the end consumer and make recommendations with regards to which coverage to purchase. Agents and brokers make money when the asset owner buys coverage from a coverage seller. Thus, their goals may be to create a closer relationship to asset owners by adding value, make the best coverage selection for asset owners based on the agent's unique knowledge of the marketplace, find coverage as quickly as possible for risk and liability related to an asset, and get commission on purchases from the policyholder of coverage, assets, and other resources.

Individuals may act on the blockchain without necessarily being one of the above listed agents or identities. For example, an asset owner may delegate authority for the maintenance or even sale of the asset to a maintenance manager or a family member. Also, someone may participate in the network by providing a referral for a sale and be paid for it.

Predictive modelers consume public blockchain data and make predictions based on that data. Because the origin of the data is unknown, predictive modelers are able to make “blind predictions” and their historical accuracy can also be published to the blockchain. This allows them to be paid for the use of their algorithm: for example, based on use (e.g., if the buyer has confidence in their past performance based on public data) and based on success (e.g., they are paid if their predications are accurate). Predictive modelers may include rating agents.

A rating agent can either be part of the coverage seller, asset owner, or an independent third party. They can estimate the value of an asset or risk using algorithmic models or industry expertise and provide that estimated value. For example, a rating agent may provide an estimated value to an asset owner looking to buy or sell an asset, or to a coverage seller trying to value an asset or the risk on top of the asset. A rating agent's goals may be to accurately evaluate the worth of an asset to buyers and sellers, accurately assess the risk or liability associated with an asset, and monetize its service on a per-transaction or subscription basis.

Outcome improvers provide tools that improve the outcomes of contracts for one or both parties in a tangible and measurable way. For example, a company that provides safety training will decrease downtime at a plant and an insurance company that provides coverage for that same plant will experience fewer losses.

Trusted history is needed by multiple participants in several areas and may be stored on the blockchain for common trusted access. For example, a customer's payment history and adherence to billing agreements may be published so that future quotes may incorporate payment risk. Claims history, from both policyholder and carrier ends, may be published to the blockchain. Identifying details of the claim, if any, may be encrypted, while fundamental data about the claim itself (e.g., type, amount, days since incident, date filed) may all be published to the blockchain. Similarly, carrier handling of claims may also be published to the blockchain so that visibility is provided to both the agent and the policyholder. The claim handling information may include information such as the adjuster assigned to the claim, current status, reserved amount, and more.

Further examples of trusted history include commitment adherence history. When a commitment is made for any purpose, its rules and logic are published to the blockchain. In addition, the commitment may be provided with enough riskcoin fuel to periodically check licensed exposure data streams. Any violations may be recorded to the blockchain and attached to the guilty party's permanent record.

Prediction accuracy history may also be provided to the blockchain. As predictive modelers use exposure data to create predictions, their predictions may be recorded in the blockchain. This provides indisputable, immutable and tamper-proof evidence of accuracy against real risk relevant to carriers and agents. In another example, exposure data and events may be provided to the blockchain. Exposure data may have an owner as well as licensees to use it. Exposure data may be brought into the system from external providers and used as part of resulting transaction contracts.

The system provides for any number of commitments to be stored on the blockchain, such as safety and training, data access, subsidy agreements, value-adds, outcome improvers, and agency and carrier commitments. For example, in many instances, safety and training can improve a risk significantly. Such training may include slip and fall training, narcotics handling compliance and sexual harassment training. By using behavioral commitments to, for example, put all employees of a company through one of these training classes with the employees subsequently passing a test, a carrier may reduce the risk inherent in a policy.

With regard to data access, a commitment to provide access to data may be encoded in the blockchain so that the data stream cannot be turned off. For example, if a training app is used to deliver training that the policyholder has committed to as part of the policy, it can check with the commitments on the blockchain before allowing the user to turn the data access off. For subsidy agreements, carriers may subsidize value adds and outcome improvements for policyholders, which may be scaled as needed. For example, a carrier may subsidize sensor packages to detect and mitigate water leaks, which helps keep buildings in operation and reduces losses.

For value-add commitments, a carrier or agency may subsidize a value-add for a policyholder as part of a quote or as differentiation in the sales process. The value-add may result in a new stream of exposure data, which may or may not be incorporated into a commitment. Further, to agency and carrier commitments, agencies and carriers may come to agreements on volume of business to be sent to a carrier from an agency. These commitments may be stored on the blockchain or kept within private data stores, which may then be used in performance management functions of the carrier and agent tools.

As noted above, the subject technology provides for smart policies and contracts. Smart contracts may include behaviors, business rules, and logic, all stored and operating on a trusted data store. Smart policies may include the risk covered, which may be in more traditional terms such as coverage limits and may be described in terms of risk units. Smart policies may also include financial terms (e.g., payment schedule, claims handling agreements), agency commitments, carrier commitments (e.g., payment for claims), and policyholder commitments.

Another form of a smart contract is the agent-of-record contract, which describes a relationship between the individual or organization that originally has rights to a resource and another individual or organization who the individual or organization is giving agency to. A typical example of creating an agency relationship is an individual or organization signing an agency of record agreement, giving the agent the right to represent their risk in the marketplace. With smart contracts as provided by the subject technology, new types of agency agreements are now possible as well. For example, an owner of a piece of data agreeing to license the data to someone else for use, an employee assigning the employer the use of the employee's time and intellectual property, a property owner renting property, and a more complex type of relationship where the resource owner allows the use of an asset for specific use cases and/or during certain times. Further, resources as well as agency relationships may carry with them ownership and history of ownership. Resources may also include value estimates and estimate history.

Payment and billing smart contracts provided by the system include the ability to react to new data, authorize payment and billing in very transparent ways, and log outcomes such as payment delinquencies to a shared public record. Pay-per-success contracts may be based on successes and outcomes published to the blockchain, providing for compensation of participants of the system for successes.

Data licensing contracts are another smart contract, providing more visibility into policyholder operations. Such operational tools provide information about the relationships and assets of the users, such as who their employees are, who their customers are, who their supply chain includes, their revenue streams and cost structures, the equipment they own and how well they maintain it, the vehicles they rent/own and how well they maintain them, what they are working on, project deadlines and economics, their locations and facilities, their providers and suppliers, the products they make, where they deliver to, what their cash flow looks like, what their receivables are, what their value chain looks like, if they pay on time, if their customers pay on time, and how much debt they have, etc. The system may provide operational tools at no cost to participants in order to gather a unique data set to grow the system network, which benefits all participants.

Performance milestone agreements provide both agencies and carriers with the ability to establish performance goals for agencies and/or producers, which when met, have monetary rewards associated with them. These agreements may be made between agencies and carriers first, and then may trickle down to the individual producers within an agency. These agreements may be embodied in an incentive structure for the individual producers that may be surfaced in a producer-facing application.

Other smart contracts are related to pay-for-outcome improvements and pay-for-accurate predictions. Agents, policyholders, value-add providers, and modelers may be paid based on specific factors (e.g., success of their loss ratios, safety, efficacy, accuracy, etc.). Such payment may be in the system cryptocurrency, driving up utilization of the network and the value of each participant's ownership in it. In addition to improving outcomes, a universe of modelers may be given access to the blockchain so that they can make predictions about risk scoring, loss probabilities, and claim severities, for example. The predictions may be published to the blockchain so that their accuracy and authenticity are not questioned. Further, because of the way privacy works on the blockchain, predictive modelers may make predictions based on anonymous data, where identities are unknown. This allows the modelers to prove their value prior to any payment or agreement to use. The most accurate models may be used by network system participants to become better at their own tasks, and the model providers may be paid in the system cryptocurrency. The payment may be paid per use or per accurate prediction, for example.

Gain sharing agreements may also be provided by the system. In certain strategic situations, two or more members of the system may want to join forces towards a common goal, such as preventing exposure events. In that case, a gain sharing agreement may be created that defines terms of sharing monetary rewards in success. For example, an agency may pay a lower fixed fee for a lead whether it ends up converting or not, or a percentage of the premium written for a lead if and when the lead is converted.

On-demand help contracts may provide for compensating people for their time. For example, the system may compensate brokers if they are brought into a conversation in real-time to help sell a sophisticated niche coverage. The broker may get a brokerage commission at one level of assistance or a much smaller percentage of the commission if they only need to spend a few minutes explaining a nuance during a sales meeting.

Predictive model licensing contracts are another form of smart contract provided by the system. By writing predictions to a blockchain, predictive modelers may create verified predictions. The modelers may use these contracts to make their predictions available to other members of the network, either on a one-time or an ongoing basis.

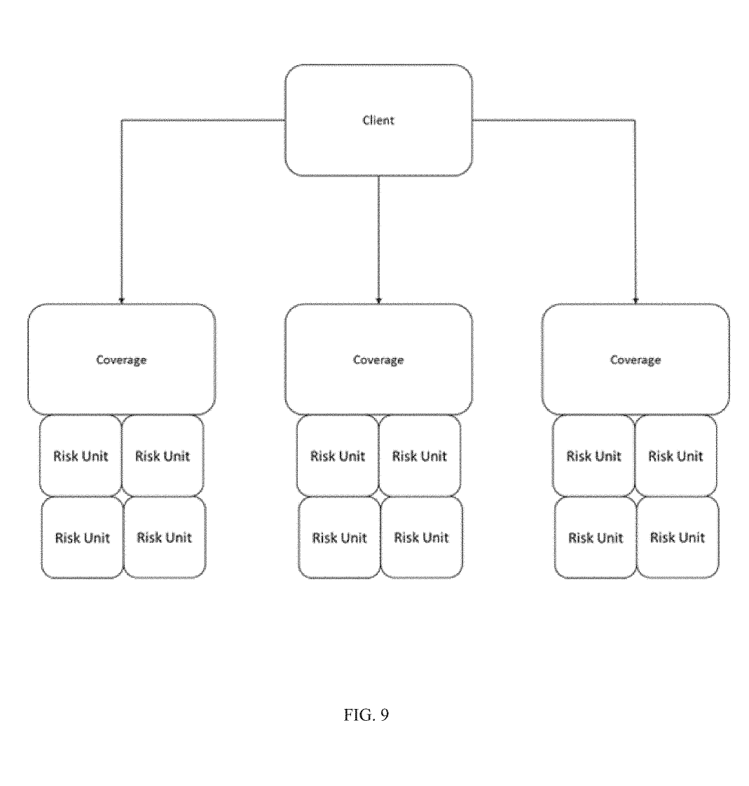

As shown in FIG. 8, the subject technology also provides several tools that assist with system networks. These tools primarily make the network more user-friendly, making it easier to use and interact with by various participants in the network, as well as adding proprietary data to enrich the blockchain data. Some of these tools are only used by agencies, others are only used by carriers, and others are used by both.

One tool shows agents and carriers how much business they have in a given market, including how many leads are being worked and potential revenue from them. It also shows agencies how much up-sell and cross-sell potential they have in their current book of business by using existing data from their book to determine which industries are likely to need which products, and how much those products are expected to cost for each client in that industry. For example, it is valuable to carriers and capital providers to see where supply is across the network. They may be interested in the supply across a number of dimensions such as geography, industry, revenue, employees, loss history, and many more. Along with seeing the volume of supply available at a given intersection of dimensions, carriers are also provided the ability to see value-adds and exposure data streams available for that specific market.

A performance management module allows agency executives to see how their organization is performing against goals, including if they are on track to hit volume commitments. These goals may be updated automatically from the associated data as events occur in the network and may include any of carrier commitments, producer goals and producer incentive structures. For example, if the agency has made commitments to a carrier for a certain volume of business, this may be measured in the performance management tool and the agency executives can see if they are tracking to achieve the goals. Also, the agency may set goals for producer sales activity such as number of cold calls, number of new policies, and number of cross-sells and up-sells within a given time period. In addition, agencies may create incentive structures that tie monetary payments to specific goals, as well as sales of specific products.

A strategic market analysis module may also be provided to view markets, including supply and demand trends, so that the carrier may expand appetite into new markets, or see which markets they should begin supplying value-adds to. The agency may look at all markets in a holistic way. As carriers use the carrier tool and a policy issuance tool, the agency can see which markets have most interest from carriers at an aggregate level. The agency can also intersect that demand information with data about which markets are growing most steadily to find out which markets to focus training and development on in order to maximize future revenue.

As the carriers define their appetite within a market, agencies and brokers are able to see which markets have more demand than others and adjust their prospecting to reflect where carrier demand is. However, as more carriers join this network, lack of appetite in a market becomes less of a concern because there will almost always be appetite for a business regardless of market. In this case, agencies may care more about targeting growth markets where their training and expertise can be scaled alongside the industry as it grows. Thus, applications may provide agencies with the ability to look at market growth statistics and projections alongside carrier demand so that they can easily identify hot spots in the market where they may want to focus their efforts and collect leads from that area.

Another tool is a producer augmentation tool that helps producers to sell insurance and value-adds to clients. This tool may provide performance management, lead management, qualifying questions, product articulation, E&O sign-off, and real-time quoting and quote selection. For example, performance management ties specific events and outcomes to monetary rewards for the producer. These rewards may be set up by the carrier or the agency and may be tied to cumulative goals or sales of new products. Lead management allows the producer to see the leads that have been assigned to the producer, as well as the opportunity size associated with each. The tool allows the producer to easily navigate to any opportunity that is either available or has been assigned to him.

The producer augmentation tool helps the producer ask the right qualifying questions in order to identify which products are relevant to the prospect. These questions may be seeded by products which are usually relevant to a prospect in a given market, and may help narrow down the products which will be relevant to the target. After identifying relevant products using qualifying questions, this app helps the producer articulate the value of products including both coverages and value-adds. This articulation can be done using text, audio, and video, and will help a producer explain the value of a product with which he is unfamiliar.

If agents do not present policyholders with all coverages relevant to them, they may ultimately be responsible for losses if the policyholder was unaware of the risk. The producer augmentation tool may collect sign-off from the policyholder that they were made aware of a risk but chose to decline coverage so that the agent is not liable for any potential future loss. Also, if a carrier has connected their policy issuance system to the system, the producer will be able to provide quotes in real-time as the data necessary for the rating model is collected and input. Further, once one or more quotes are available, the producer may use this tool to present coverages to the policyholder and make recommendations about which quotes to select for each risk.

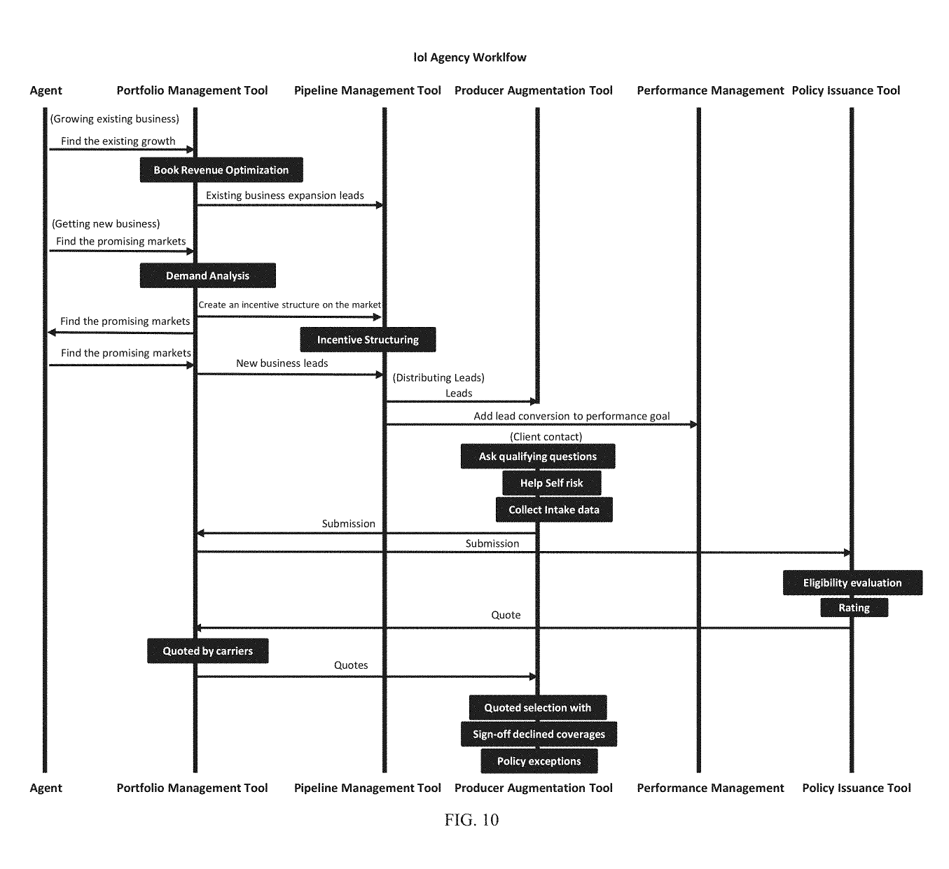

A marketplace app provides a shared resource for the entire network system configured to be useful for both carriers and agencies. The marketplace tool may provide for risk navigation. For example, both agencies and carriers have the ability to navigate available risk (see FIG. 9). Agencies and carriers may look at risk at a client level with associated risks and coverages underneath, or at a policy (coverage) level. Here, all users may see risks and policies by geography, expiration date (e.g., for existing policies), revenue, headcount, and any other market dimension that is relevant at the time. Once the correct risk or policy is found, the user may move into quote management for that risk or policy.

Quote management and collaboration is also provided by the system. As agencies submit risk and carriers quote on it, both parties need to stay up to date on the status of a given quote. The agency needs to see which carrier(s) are working on a quote, and the carrier(s) need to see where the quote is at in the process. Thus, all parties may have a common view of the current state of a given quote as well as subscribe to updates as status or data change. Thus, a value of the system is that it allows agencies and carriers to share a common view of the risk data. As the intake process takes place, and while any additional data is collected, this tool permits all interested parties to see the same view of the data. Further, the system allows carriers and agencies to collaborate around a policyholder or quote using a secure collaboration environment. They can create conversations, include other members of their organization, request files and data, and share files and supplemental data as needed.

All members of the system should be incentivized to make the policyholder safer and grow faster, because as the policyholder grows the premium grows and as the policyholder becomes safer losses decline, which benefits both the agency and carriers. This tool helps agencies and carriers see which value-adds and outcome improvers are relevant to a policyholder, and also helps to quantify the potential impact of each based on historical efficacy. When these value-adds are identified, it may encourage the agency or carrier(s) to subsidize these value-adds for their own benefit, and further include a commitment to subsidize them in the resulting quote. This may result in a fairly straightforward return on investment (ROI) calculation for both the agency and carrier for each quote based on how different value-adds will help the policyholder. Thus, the agency may help the policyholder select the best quote based on the ROI to the policyholder.

With regards to risk securitization, as risk is input either directly into the marketplace or from a servicing portal, agencies may use the system to break the risk into units of risk that may be published to carriers for quoting. This allows agency users to select the bounds of the risk layers as well as how many risk units of varying sizes to create for each layer. Carriers may also use this tool to slice existing coverage into risk units for resale to reinsurers. Managed General Agencies (MGA's) are enabled to do both.

A lead distribution module is a live updating in a real-time interface where an agency can see leads provided by the system within a market, look at an anonymized profile of a lead, pay a small amount of system cryptocurrency to see a lead, and pay more system cryptocurrency for claiming the lead and taking it off of the open market. This allows an agency to claim a lead, and also helps the agency executive distribute the lead to the producer who is most likely to be successful with it based on their history selling into the market the lead is in, ability to learn new markets, or availability.

A clearance module is also provided. Clearance is the ability for a carrier to make sure that an agency has the broker-of-record relationship with the policyholder and the carrier has not quoted this policy with another agency. The broker-of-record relationship may be published to the blockchain, which makes it fully transparent and easy to determine. The system centralizes quoting with all agencies so that the carrier is guaranteed to never quote the same policy twice. In addition, by mapping the structure of complex organizations including subsidiaries and affiliates, clearance may be made even more robust by taking into account relationships between the carrier and other arms of an organization. Further, by connecting directly with a policy issuance tool, a carrier may instantly quote policies matching eligibility requirements and parties whose required data is fully available.

The policy issuance tool takes units of risk that match a carrier's appetite and feeds them into a rating model for pricing. The output is a price, terms, conditions, and potentially value-adds that make up the quote.

The policy issuance tool provides for managing carrier appetite. By defining appetite at a market level, carriers may define the business that they are sent at a very granular level. This tool includes the ability to set desirability, gates, and alerts for business in a given market. Carriers may manage their appetites by defining markets that they have interest in. Traditionally this would be done by creating a spreadsheet that defines how they will react to a quote with certain characteristics. These characteristics would typically revolve around a SIC or NAICS code, and would map to how the carrier will handle a submission for this type of business. For example, they may say that they will write coffee shops automatically, while delivery companies would require manual approval, and they will never write policies for dynamite factories. The subject system defines the intersection of a number of dimensions as a “market.” Therefore, the system gives carriers the ability to define their appetite within a given market, not just at an industry level, and across a multitude of other dimensions as well.

Aside from strict appetite, eligibility requirements may be set for each market. Thus, aside from just defining whether a given piece of business is desirable, the carrier may set thresholds on how that market should be treated. This includes the ability to automatically approve coverage for risk in a market or to require manual approval before agreeing to a policy. Eligibility may also be used to automatically approve subsidized value-adds for a given market.

A market specifies the dimensions of product or organizational attributes so that parties interested in a similar set of attributes can find one another and transact business in a marketplace. A marketplace in this sense is almost ephemeral or virtual as it exists only as the appetite for its characteristics exist, and ceases to exist when appetite for its characteristics change or go away. A market is equivalent to a class of business in insurance (e.g., a business operating policy for the abrasive wheel manufacturing industry). Whether explicit or implicit, a coverage seller will have an evolving appetite for every market (e.g., a coverage seller might have no appetite for the entertainment market). Given a party's appetite along one dimension (e.g., business operating insurance), the system may fine-tune or infer the party's appetite within that market even further.

Market dimensions may include SIC Code for an industry (e.g., floral), NAICS code for an industry (e.g., floral), a proprietary code used only by the organization populating the record (e.g., a proprietary carrier code for a line of business), the number of employees in an organization, the top-line revenue of an organization, the political states included in this market, insurance line of business, the asset type in the market, etc. More than one value may be used in a key (e.g., florists AND iron and steel forgings).

A market's profile may also include a number of key statistics. For example, known universe (e.g., a list of which assets or risks match a market's dimensions both in total and by geography). Also, a list of assets and risks that match a market's dimensional criteria may be available either as a query or a precomputed list within the market itself. This may be provided by tagging assets and risks with matching markets as the markets and/or the organizations are updated. Other examples include, but are not limited to, trends over time (e.g., number of businesses, amount of volume transacted), current demand (e.g., aggregate appetite measurement statistics), current supply (e.g., aggregate appetite quantification statistics), current price (e.g., aggregate bid/ask statistics), conversion rate (e.g., aggregate transaction statistics), etc. A snapshot of the current state of the market may be taken on a periodic basis (e.g., daily, hourly, etc.) so that trends can be observed over time.

A market appetite describes a party's interest in a market. Both buyers and sellers have appetites for a given resource, including potentially to both buy and sell the underlying asset in a market (e.g., as an arbitrage play). As an appetite evolves over time, a snapshot of the current state of an appetite may be taken on a periodic basis.

A defined appetite may have a number of properties. For example, market (e.g., an appetite is associated with a single market), organization or person (e.g., an appetite is associated with a single organization or person), appetite type (e.g., appetites may be either explicitly defined by the supplier or the customer, or implicit based on behavior and historical actuals), visibility Public/Private/Shared (e.g., some parties may wish to publish their appetite such as insurers publishing their explicit appetite for new business, or they may not want to because of a variety of reasons, such as an insurer who wants to move into a new market but not alert their competition), appetite size (e.g., the size of the appetite in the scale determined by an appetite size scale attribute), appetite size scale (e.g., the scale used to dictate the size of the appetite, such as US dollars, quantity, cryptocurrencies), requires approval (e.g., if a transaction in this asset or risk class requires approval to buy or sell, this will be true, otherwise the transaction can be approved instantly from this side), special approval required (e.g., if a transaction in this market requires any kind of special or exceptional approval, this will be true and indicates a harder transaction to complete), automatic quote eligible (e.g., if a certain market is eligible to be quoted on the internet or via other electronic means), appetite comments (e.g., additional explanatory comments), and historical conversion rate (e.g., the buyer's or seller's historical conversion success on this market), etc.

The policy issuance tool is enabled by a metadata layer hosted by the system and which maps defined data elements to parameters for rating models. By doing this, the values for data needed for rating may be fed into rating models in real-time, enabling carriers to provide real-time quotes to agents and policyholders.

The system also may include a servicing portal that is open to everyone in the system, providing access to coverage details as well as an easy way to interact with the blockchain. The servicing portal may manage participant's private keys and provide a user friendly interface (e.g., Web application, tablet application, or mobile application). Since all participants of the system have access to the servicing portal, the system can harness any participant's ability to improve data quality by exposing it in the servicing portal (e.g., allow policyholders to edit data about themselves).

Agents and carriers may send requests to policyholders for additional data needed to underwrite risk. After selecting a data element needed and sending it to the policyholder, the policyholder may then input that data into the servicing portal directly rather than requiring an agent to collect it and send it to the carrier. The system also provides for incentivizing any participant in the network system to improve data quality by paying them when they add missing data, mark data as incorrect, validate that data is correct, or provide corrected data, for example.

The servicing portal provides relationship and identity verification. Relationship verification allows any member of the network system to verify a relationship. For example, a policyholder may use the servicing portal to digitally sign an agent of record relationship. Identity verification provides participants an easy way to identify themselves definitively to the network. For example, a person may claim their identity in the network by signing a transaction with their private key.

Transaction signing is also provided by the servicing portal for all types of transactions including risk sales, coverage purchases, data licensing, and so on. The portal also may determine if a logged-in user has proper authority to sign for the transaction. Coverage viewing is provided by the servicing portal when policyholders, agents, and carriers need to view coverage details for assets. Thus, the servicing portal may show, for each covered asset, what the covered perils are, as well as the covered units of risk (e.g., including layer bounds).

The servicing portal also provides for billing and payment viewing and claims handling. For example, all participants in a transaction may see billing agreements, see payment history and update billing information. Also, agents, policyholders, or carriers may submit claims on behalf of a policyholder. In addition, each member may subscribe to view the current status of a claim, subscribe to updates and create follow-up messages (including requests for more information).

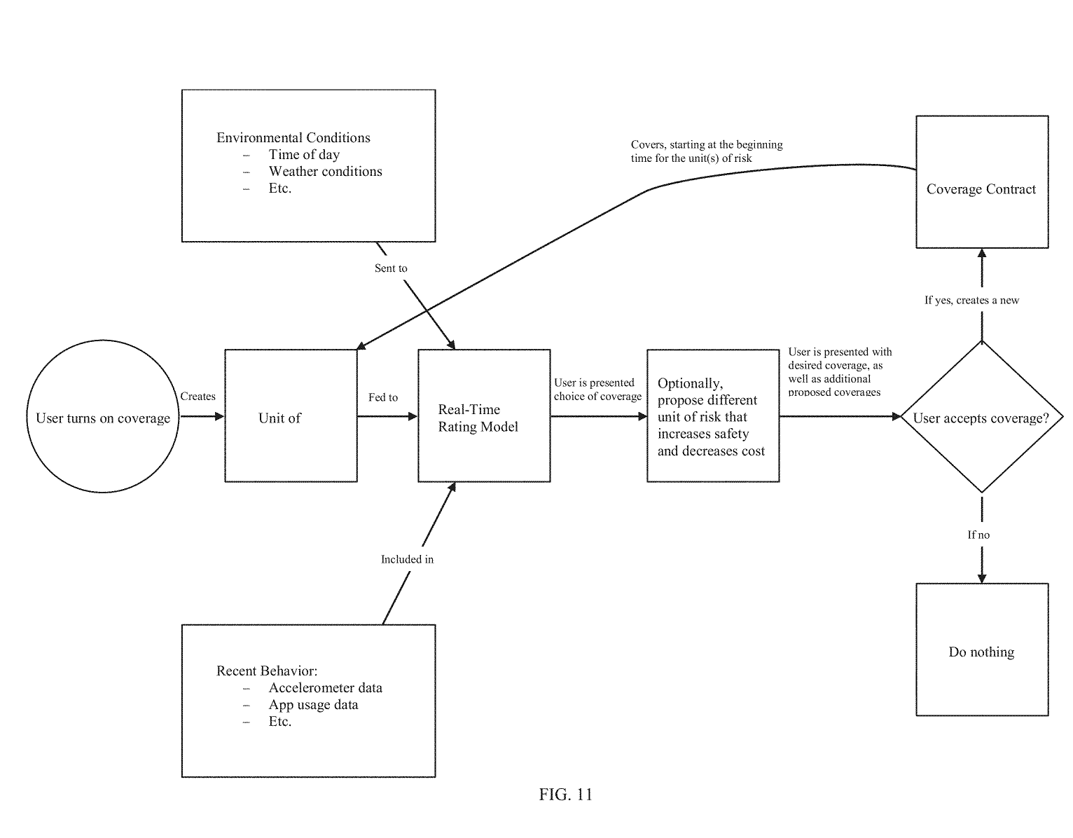

FIG. 10 illustrates an example agency workflow utilizing the system. Here, the system provides several tools that vastly improve the efficiency of the agency workflow. For example, a portfolio management tool and a pipeline management tool are each utilized by the agent to grow existing business, sell new business and handling quotes with carriers, while the pipeline management tool is also used for distributing leads. A producer augmentation tool is used for distributing leads, client contact and quoting policies. A performance management tool also is utilized in distributing leads. In addition, a policy issuance tool provides for quoting and submission of policies.

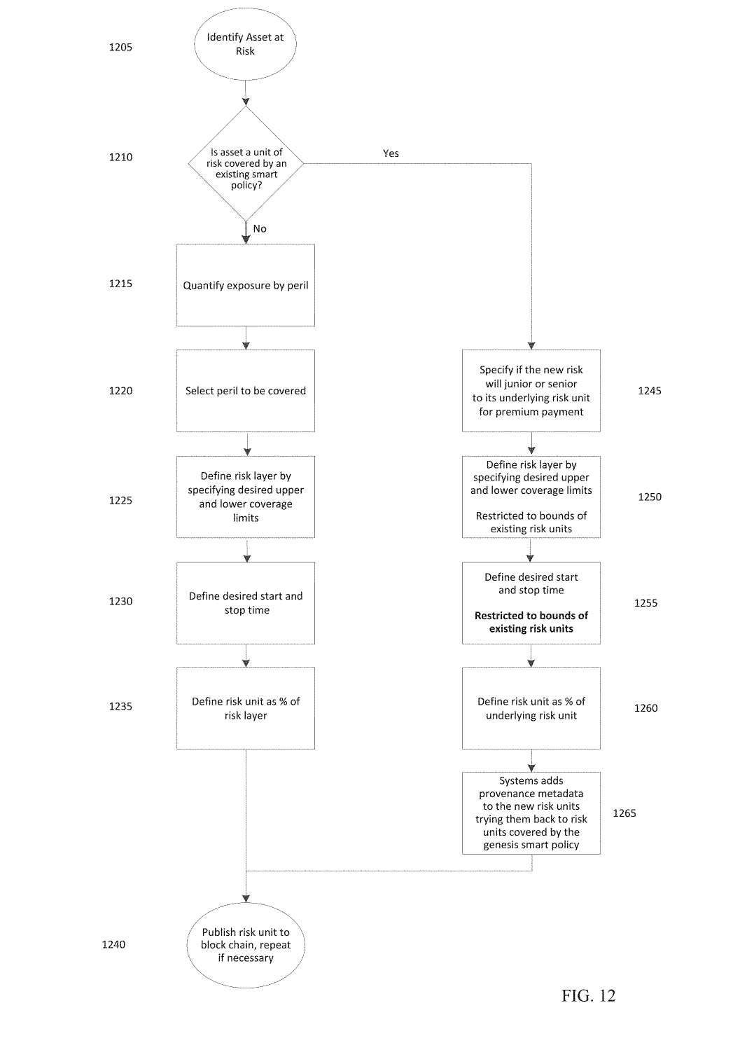

The system provides for a unique workflow enabled by the transparency provided by blockchain solution, which enables on-demand coverage. With reference to FIG. 11, by allowing environmental conditions such as time-of-day and weather conditions to be included as exposure data, rating models may be upgraded to include this information. Thus, the system may provide pricing on risk units that are far more granular along the time dimension than traditional policies. For example, risk units may be created for the next 15 minutes just prior to use, and rating models that were built to rate risk at that level of granularity will be able to price those risk units.

The creation of risk units may be done from a mobile application. This provides for the rating model to incorporate data from the mobile device, such as accelerometer data for information on hard braking, app usage while driving, time in transit, local weather conditions, and time of day, etc. This information allows rating models to become even more intelligent and to take contextual exposure data into account while pricing.

Assets, risks, and bids/asks are all aggregated by the system and may be published for public or private consumption. An asset marketplace allows asset owners to post assets for sale, and allows asset owners and/or their agents to post risk units. The marketplace also maintains an asset and risk history, including ownership, maintenance, improvements, and other elements which materially affect the value of the asset or risk. The act of publishing this data either publicly or for a limited audience is done by the choice of the data owner, and is effectively the same as posting an “open for business” sign. The marketplace component may hold this data internally or publish it for public consumption, including onto a blockchain. Certain data elements may be held back from the public, such as name or address in order to anonymize data for privacy.

The asset and risk publishing component includes several user interface elements. For example, the ability for an asset owner to publish an asset to a marketplace for sale, with or without a published asking price. Also, a preference control panel where asset or risk owners may decide how much information they want to share publicly, along with the ability to grant another party visibility to additional (e.g., previously private or hidden) data to help facilitate a transaction. Further, an asset profile for marketplace participants which displays all of the relevant information about an asset including its ownership history, current owner, improvements, accident history, and value estimates from rating agents. Here, the amount of information shown is controlled by the asset owner.

Asset owners or their representative agent may publish risk units to the marketplace either directly using provided user interfaces or via the system automatically posting risk to the marketplace (e.g., by use of conditional rules that describe the conditions under which risk should be automatically published). To facilitate a coverage purchase transaction, the asset owner or their representative first publishes units of risk to a blockchain, which is exposed in a marketplace. The exposure data pointed to by a unit of risk, as described above, is first collected either manually or via operational tools.

User interfaces are provided by the system to facilitate publishing risk for coverage. For example, the ability for an asset owner or their agent to publish the risk units associated with the asset to a marketplace, with or without a published bid price for coverage. Also, a risk unit profile for marketplace participants to see aspects of the risk including a link to the profile for the underlying asset, asset owner, and any risk or value estimates available. Further, a user may specify the desired coverage time period or to begin on a periodic (by the minute, hour, day, month, etc.) basis until canceled. An interface may allow asset owners or their agents to unpublish or de-list risk from the marketplace. Also, an interface may allow asset owners or their agents to construct a coverage bid to publish to the marketplace for immediate acceptance. Further, an interface may allow asset owners or their agents to manually input exposure data (e.g., an automated equivalent to ACCORD forms that are used today). The risk may then be published to the marketplace by the asset owner and/or their agent. The risk may also be published only to specific coverage sellers (e.g., equivalent to the current workflow of submitting to a select few partner carriers).

Coverage sellers are able to locate risk published to the marketplace (e.g., portfolio service) and make informed decisions about if they should offer coverage. Once the risk has been identified, a coverage proposal (e.g., a “quote” or an “ask” in traditional marketplace terms) is constructed with the properties described above regarding coverage proposals. This coverage may then be published to the marketplace where agents can see and present it, and asset owners can choose to buy it. In many cases, the coverage proposals from multiple parties may be considered, and the asset owner's agent may make a recommendation on which coverage to select based on a number of parameters (e.g., pricing, seller reputation and solvency, the types of value-adds offered by the coverage seller, and terms and conditions of the coverage).

User interfaces are provided by the system to facilitate coverage proposal and selection. For example, an interface that allows coverage sellers to define their appetite in various markets, an interface that allows coverage sellers to search for risk matching their appetite, an interface that allows coverage sellers to view details of risk including exposure data, an interface that allows coverage sellers to request additional information about a risk, an interface that allows coverage sellers to propose a different exposure base for a unit of risk, an interface that allows coverage buyers, sellers, and agents to collaborate via text, video, and file exchange, and an interface that allows coverage sellers to construct a coverage proposal including terms and conditions.

The marketplace component handles all transactions and may include a number of interfaces. For example, an interface that allows coverage buyers to review all coverage proposals, an interface that allows coverage buyers to tweak coverage proposals in order to create a counter-proposal bid, an interface that allows coverage buyers to accept a coverage proposal, an interface that allows coverage sellers to accept a coverage bid, an interface that allows coverage sellers to electronically sign a transaction either before or after the buyer has agreed to the transaction, an interface that allows buyers to electronically agree to transaction and an interface that shows the resulting smart contract prior to submission and clearance.

When a transaction has been agreed to by both parties, the system may allow the buyer and seller to sign the transaction using their private keys and publish the resulting smart contract to a public or private blockchain and provide each party with a reference to the contract. Here, an insurance policy is primarily a smart contract, although it may include references to standard and published documents hosted outside of the smart contract, including assets and units of risks documented on other blockchains or in other data stores. Thus, by publishing these contracts and their linked resources to a shared immutable and tamper-proof blockchain, trust is increased, speed in increased and ease of doing business goes up.

Insurance policies can continue to exist outside of the system by including references to transactions and assets inside the marketplace and using their unique identifier within the network. However, by embodying insurance policies as smart contracts on the system, the policies can be living entities that validate their own terms and conditions and react to external stimulus and exposure data. The system itself will execute the published smart contracts, triggering everything from claims to billing.

A preferred method of embodying insurance policies is as smart contracts with all terms and conditions included. The data needed to evaluate the state of a contract may be obtained by calling out to external services at the time verification data is needed. The data may also be accessed from a blockchain and referenced by the contract so that the state of the contract is completely deterministic and may be re-derived at any point using the data on the blockchain.

Aside from risk, exposure data can also provide clear visibility into the operations of the business. This visibility into operations provides unique opportunities to offer several value-added operations to a business. For example, the system may combine usage pattern information with resource inventories (e.g., people, risk, equipment, vehicles, leads, facilities, and raw material) to calculate a relative value for each resource to the user. The system may use resource inventory and usage pattern information to identify resource surpluses and help participants offer surplus resources to a marketplace for sale or temporary use, potentially charging a transaction fee. In another aspect, the system may assess resource age, configuration and usage patterns to recommend purchases, upgrades, or replacements, including economics such as net present value (NPV) and/or return on investment (ROI). Similarly, the system may also identify and assess resource shortages and recommend resources from a marketplace for purchase or temporary use, including economics such as NPV and/or ROI. Also, the system may combine resource usage pattern information with job information and information about individual people (e.g., a delivery vehicle being driven by a specific user to deliver a specific load) to quantify the risk associated with the entire chain and price it on a variety of unique exposure bases, which can be turned into units of risk.

Because of this visibility into policyholder operations and activity, the system may identify potential opportunities very quickly and match them with an inventory of products from solution providers. These products can include both insurance products as well as other types of products. For example, consulting or expertise services including legal and human resources (FIR), equipment rental or sales, vehicle rental or sales, insurance coverage against risk, labor (e.g., people) on a permanent or temporary basis, software solutions for specific use cases, real estate rental or sales, and training programs or other content.

These opportunities to add value provide a multitude of ways for the system to monetize the transaction by making recommendations to the user. For example, if the user follows the recommendations, these monetization mechanisms may include, charging a transaction fee (e.g., fixed or variable) when an asset or risk unit is purchased or contracted against (e.g., through purchasing, renting, or otherwise creating an obligation for use or ownership), charging a fee for introducing a potential buyer to a solution provider, and charging a fee for as long as variable resources are in use (e.g., when facilitating the renting of a piece of construction equipment we may charge by the hour for arranging its use).

To accelerate population of the marketplace, the system provides agents and brokers with tools that help them drive revenue by giving them talking points based on the behavioral science profile of their prospects and helping them match value-added tools (e.g., the operational tools discussed above). For example, the system may provide a commission, referral and marketing service where agents may be paid commission, insurance companies may be paid ceding commissions, or businesses or individuals may be paid referral or marketing fees. As another example, negotiation services may include data license agreements and commitment agreements. An asset service may be based on an asset that carries risk of loss or liability and is owned by the risk bearer/coverage buyer, and for which the owner wishes to buy coverage to protect against risk. The asset may be any valuable or risk-bearing asset and the asset service may provide asset tracking and/or ownership records.

An asset improvement service may provide aspects such as training and risk improvement. An audit service may verify commitments, define changes in risk or an asset, or evolve attributes of a risk and changes in the underlying asset form or value. The system may also provide claims services (e.g., adjust, approve) including, a claim handling service that adjusts and pays claims, and publishes resulting activity to the marketplace, a claim integration service for public adjusters, repair facilities, and coordination of those services with communication, notifications and documentation, and a subrogation service that allows for collection of claim dollars owed by another party.

A payments service may include services for billing, collections, and payment disbursement. For example, a billing service may collect and distribute premiums and payments and publish resulting payment history to a blockchain. A portfolio service may help price risk and assets for buyers and sellers both. For example, a pricing model may determine a price for coverage that fits with the buyer's budget and the coverage seller's investment strategy. This pricing model may be published to a blockchain or otherwise made available to regulators for audit purposes. A variety of pricing models may be made available, including proprietary models and models built by third-party provider. A pricing model may be based on financial models, experience rating models, exposure rating models, simulation models, catastrophe or other event based models (e.g., terrorism models), a frequency distribution and a severity distribution.

The system may also provide an underwriting service. Here, an underwriting model may determine terms and conditions for a smart contract through a menu of available risk bundles, triggers, coverage terms, deductibles, limits, layers, proportions, covered perils, excluded perils, contract basis and smart contract code. A safety engineering service may provide for safety engineering services to be given away, purchased or sold and linked to assets, and provide commitment documentation. A training service may provide training for employees, independent contractors, vendors, suppliers, or consumers, any of which may select free or fee based training with documentation of completion.

### Example System Architecture

Architecturally, the subject technology can be deployed anywhere. For example, it may be preferable to operate on a very powerful server, in particular one with parallel processing capabilities. When used in the cloud, the system may be deployed with a central database, which may leverage a network of other servers to spread the load of the system. Users (e.g., participants) may access the system either via a webpage or via an application programming interface (API) implemented within an existing system (e.g., within an agency system used by an agent to identify a client risk and provide the appropriate risk coverage).

In one or more embodiments, the system may be deployed on a very powerful server, in particular one with parallel processing capabilities. Graphics cards may be used as optimizations for processing more operations in parallel. In one or more aspects, the generated workload may be optimally distributed across multiple different physical computers.

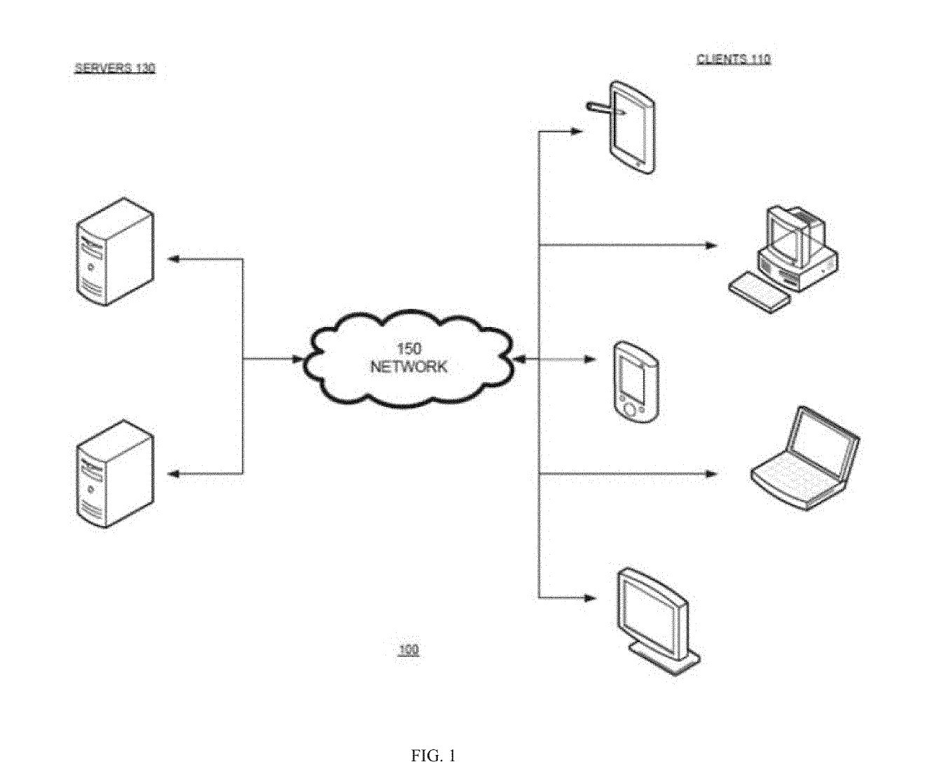

FIG. 1 illustrates an example architecture 100 for an automated interconnection system for recording and transferring ownership of insurance-related assets. The architecture 100 includes servers 130 and clients 110 connected over a network 150.

The clients 110 can be, for example, desktop computers, mobile computers, tablet computers (e.g., including e-book readers), mobile devices (e.g., a smartphone or personal digital assistant), set top boxes (e.g., for a television), video game consoles, or any other devices having appropriate processor, memory, and communications capabilities for querying, storing and/or analyzing data. The system provides interconnection of any combination of servers 130 and clients 110 over the network 150, stores insurance related content on one or more databases on one or more servers 130, and processes the content to provide value data to various participants (e.g., calculate units of risk, dispense cryptocurrency rewards).

One or more of the many servers 130 are configured to analyze each form of insurance content and store the analysis results in a database. The database may include, for each content item in the database, information on the relevance or weight of the content item with regards to user input received from a client 110. The database on the servers 130 can be queried by clients 110 over the network 150. For purposes of load balancing, multiple servers 130 can host the database either individually or in portions.

The servers 130 can be any device having an appropriate processor, memory, and communications capability for hosting any portion of the above-described insurance related applications and databases. The network 150 can include, for example, any one or more of a personal area network (PAN), a local area network (LAN), a campus area network (CAN), a metropolitan area network (MAN), a wide area network (WAN), a broadband network (BBN), the Internet, and the like. Further, the network 150 can include, but is not limited to, any one or more of the following network topologies, including a bus network, a star network, a ring network, a mesh network, a star-bus network, tree or hierarchical network, and the like.

In another embodiment the system can be deployed on a distributed virtual machine and run by the network itself. In the case of Ethereum smart contracts for example, the code for smart contracts is itself written to the blockchain and the network executes the contracts so that no single entity is in control of running the contracts. This again provides absolute faith in the immutability of the contract and all participants in the network can be sure that it is running as promised.

### Example Interconnect System for Insurance Related Assets

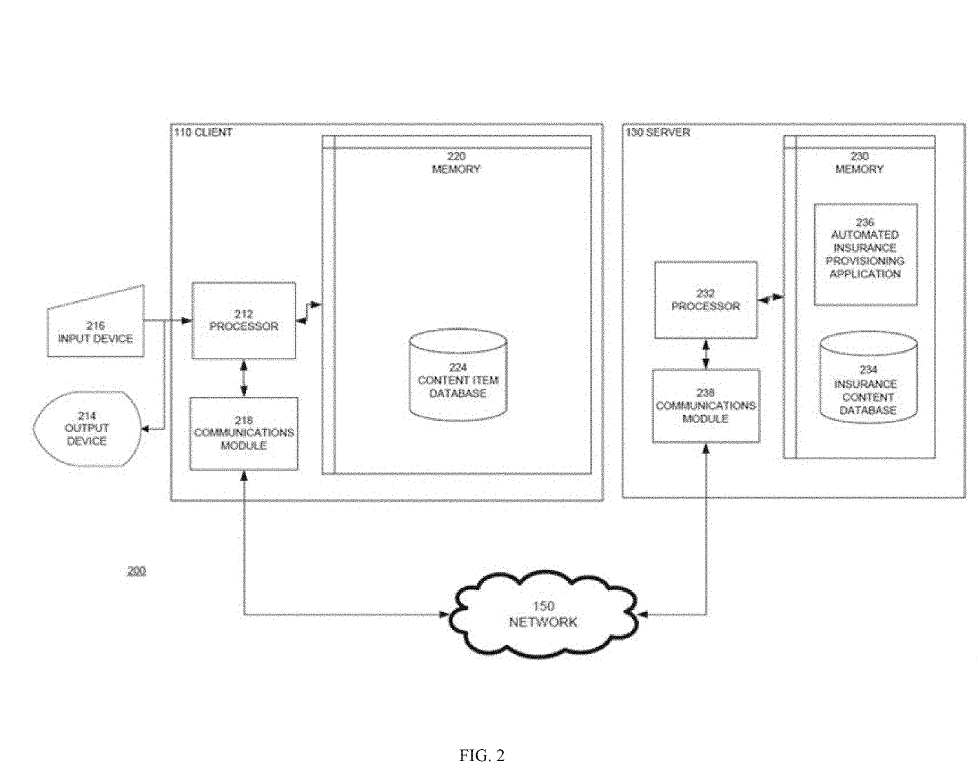

FIG. 2 is a block diagram 200 illustrating an example server 130 and client 110 in the architecture 100 of FIG. 1 according to certain aspects of the disclosure.

The client 110 and the server 130 are connected over the network 150 via respective communications modules 218 and 238. The communications modules 218 and 238 are configured to interface with the network 150 to send and receive information, such as data, requests, responses, tools and commands to other devices on the network. The communications modules 218 and 238 can be, for example, modems or Ethernet cards. The client 110 also includes an input device 216, such as a stylus, touchscreen, keyboard, or mouse, and an output device 214, such as a display. The server 130 includes a processor 232, the communications module 238, and a memory 230. The memory 230 includes an insurance content database 234 and an automated insurance provisioning application 236.

The client 110 further includes a processor 212, the communications module 218, and a memory 220. The memory 220 includes a content item database 224. The content item database 224 may include, for example, a link to an existing insurance policy and data regarding risks and perils related to the entity covered by the policy, each which may be interacted with by a user of the client 110. The client 110 may be configured to initiate one or more user inputs related to a content item from the content item database 224, querying the insurance content database 234 on the server 130 for additional content relevant to the user inputs, and receiving and storing relevant information and/or quotes received from the automated insurance provisioning application 236 on the server 130.

The processors 212, 232 of the client 110, server 130 are configured to execute instructions, such as instructions physically coded into the processor 212, 232 instructions received from software in memory 220, 230 or a combination of both. For example, the processor 212 of the client 110 may execute instructions to generate a query to the server 130 for content items based on user inputs, to receive content from the server 130, to store the received content in the content item database 224, and to provide the content for display on the client 110. The processor 232 of the server 130 may execute instructions to obtain new information from any participant of the system, to analyze/process the new information and store the results in the insurance content database 234, to generate new content from the insurance content database 234, and to provide relevant content to the client 110. The client 110 is configured to request and receive relevant content to/from the server 130 over the network 150 using the respective communications modules 218 and 238 of the client 110 and server 130.

Specifically, the processor 212 of the client 110 executes instructions causing the processor 212 to receive user input (e.g., using the input device 216) to generate a query out to other devices through the network 150 and to store received content data within the content item database 224. For example, the user may type in a request for specific risk coverage on the client 110, which then generates a query out to any insurance provider resources on the network 150.

The processor 232 of the server 130 may receive from the client 110 a set of user inputs to use in monitoring for new relevant content or as the basis for generating a direct response to the user query. The processor 232 of the server 130 may execute the automated insurance provisioning application 236 over the inputs provided by the client (e.g., prospective risk investor). The processor 232 of the server 130 may then execute the automated insurance provisioning application 236 to generate a quote (e.g., insurance policy quote, unit of risk pricing valuation) to the client 110.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

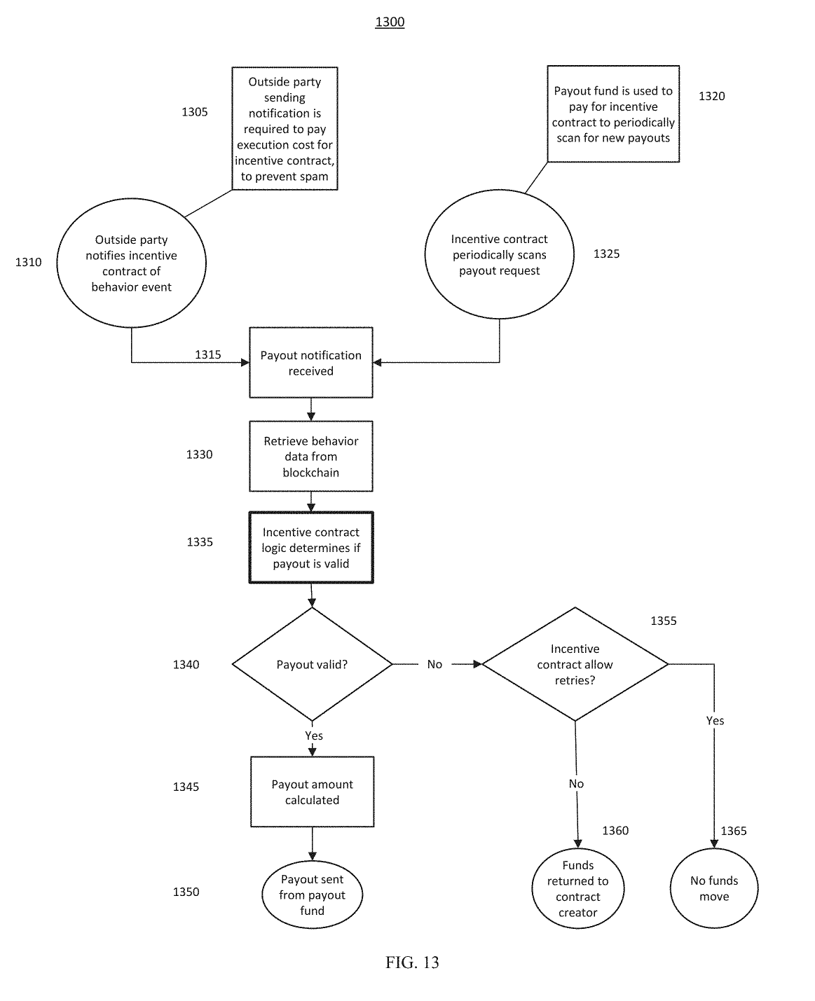

FIGS. 12-14 illustrate example processes 1200-1400 of an interconnect insurance system using the example server 130 of FIG. 2. While FIGS. 12-14 are described with reference to FIG. 2, it should be noted that the process steps of FIGS. 12-14 may be performed by other systems.

As described above, the system provides for determining and leveraging risk securitization, as illustrated in the example risk securitization 1200 of FIG. 12. In step 1205, the system identifies an asset at risk. An important consideration is that asset may be an original asset belonging to a policyholder, or it can be a unit of risk that the user wishes to securitize further. The system determines if the asset is a unit of risk covered by an existing smart policy in step 1210. If the asset is not a unit of risk covered by an existing policy, the system quantifies the level of exposure by peril in step 1215. In step 1220, the peril to be covered is selected, and a risk layer is defined by specifying desired upper and lower coverage limits in step 1225. In step 1230, a desired start and stop time are defined, and in step 1235 a risk unit is defined as a percentage of a risk layer. The defined risk unit is published to the block chain in step 1240.

If the determination in step 1210 is that the asset is a unit of risk covered by an existing policy, then the system specifies if the new risk will be junior or senior to its underlying risk unit for premium payment in step 1245. In step 1250, the risk layer is defined by specifying upper and lower coverage limits. Here, the defined risk layer may be restricted to bounds of existing risk units. In step 1255, a desired start and stop time are defined, which again may be restricted to bounds of existing risk units. In step 1260 a risk unit is defined as a percentage of the underlying risk unit. The system adds provenance metadata to the new risk units in step 1265, tying them back to risk units already covered by the smart policy. The new risk units are published to the block chain in step 1240. The risk securitization 1200 may be repeated as necessary and/or continuously.

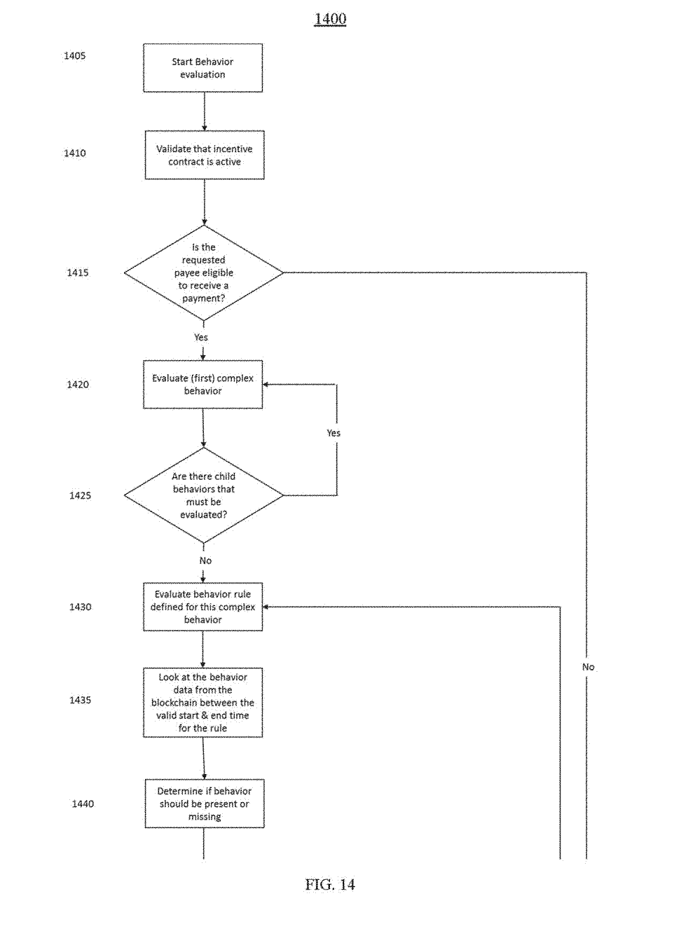

With regard to FIG. 13, incentive contracts are smart contracts which live on the blockchain and create an incentive contract between one or more parties. They may be established between a carrier and a policyholder to incentivize adherence to policy commitments, for example. Incentive contracts may also be established between a carrier and an agency to provide incentive payments for meeting levels of business. They may be created and funded when a blockchain network is formed to incentivize behaviors in the network itself in a way that is not controlled by any party.

Because incentive contracts are smart contracts, someone must pay to run the contract code (e.g. paying “gas” to fund execution of smart contracts running in a blockchain's virtual machine). This cost may be paid from the funds escrowed by the incentive contract, but it may also be provided by outside third parties. FIG. 13 illustrates and example 1300 of the system running a smart incentive contract.

In step 1305, an outside party sends a notification to the smart contract requesting a payment resulting from an incentive. In this case the sender of the notification is required to provide the funds to run the smart contract. This prevents notifiers from draining the smart contract of escrow funds and prevents abuse such as spam or denial of service attacks. In step 1310, the outside party notifies the incentive contract of a behavior event. A payout notification is received by the system in step 1315. In conjunction with steps 1305 and 1310, funds can be deposited into the contract to pay for an incentive contract to periodically scan for new payouts in step 1320. In step 1325, the incentive contract periodically scans the blockchain for new payout requests, which then proceeds to the payout notification step 1315.

In step 1330, behavior data is retrieved from a blockchain. Incentive contract logic is obtained to determine if a payout is valid in step 1335. The system then determines, using the incentive contract logic, if the payout is valid in step 1340. In step 1345, the payout amount is calculated if the payout is determined to be valid, and the payout is sent from the payout fund in step 1350. The payout may be in cryptocurrency sent to the payee's cryptocurrency wallet. If the payout is determined not to be valid, the system determines if the incentive contract allows for retries in step 1355. In step 1360, the funds are returned to the party who funded the contract if the contract does not allow for retries. If the contract does allow for retries, no funds are moved in step 1365, and the process 1300 may be restarted.

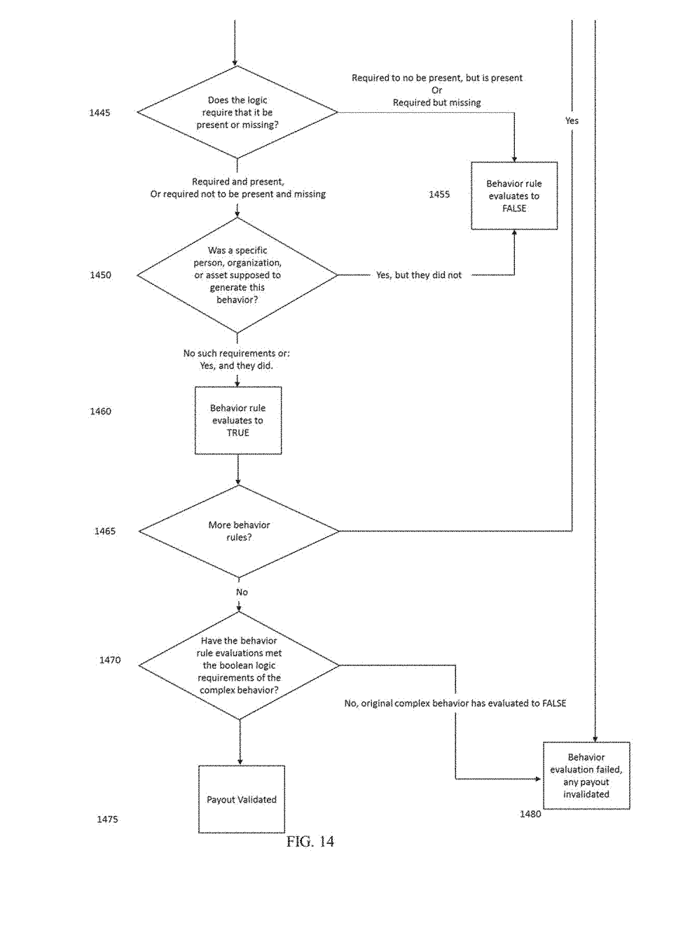

FIG. 14 illustrates a process 1400 for evaluating incentive contract logic as identified in step 1335. In step 1405, the system begins a behavior evaluation, and validates that the incentive contract is active in step 1410. In step 1415, the system determines if the requested payee is eligible to receive a payment, for example some contracts may include a whitelisted list of preapproved payees or a blacklisted list of blocked payees. If the payee is not eligible for payment, then the behavior evaluation is failed and any payout is invalidated in step 1480. If the payee is approved, a first complex behavior is evaluated in step 1420, and a determination whether there are any child behaviors to be evaluated is made in step 1425. Complex behaviors include rules for how the Boolean evaluation of child behaviors should be combined and evaluated. If there are child behaviors to be evaluated, the process loops back to step 1420 to evaluate each child behavior. If there are no more child behaviors to be evaluated, then in step 1430 the system evaluates the behavior rule defined for the complex behavior. In step 1435, the behavior data from the blockchain between the valid start and end time for the rule is evaluated. A determination is made whether a behavior should be present or missing in step 1440.

In step 1445, it is determined if the logic requires that the behavior be present or missing. If the behavior is required and it is present (e.g., employee passes a safety certification), or if the behavior is required to not be present and it is missing (e.g., employee does not test positive for drugs), it is determined whether a specific person, organization or asset is supposed to generate the behavior in step 1450. If there are such requirements but the determined entity did not completed the requirements, the behavior rule is determined to be false in step 1455 and the process starts again at step 1445. If there are no such requirements or if there are such requirements and the determined entity completed the requirements, the behavior rule is determined to be true in step 1460.

In step 1465, it is determined if there are any more behavior rules. If yes, the process returns to step 1430 and evaluates the next complex behavior rule. If no, it is determined in step 1470 if the behavior rule evaluations meet the Boolean logic requirements of the complex behavior. If yes, the payout is validated in step 1475. If no (e.g., the original complex behavior has evaluated to false), then the behavior evaluation is failed and any payout is invalidated in step 1480.

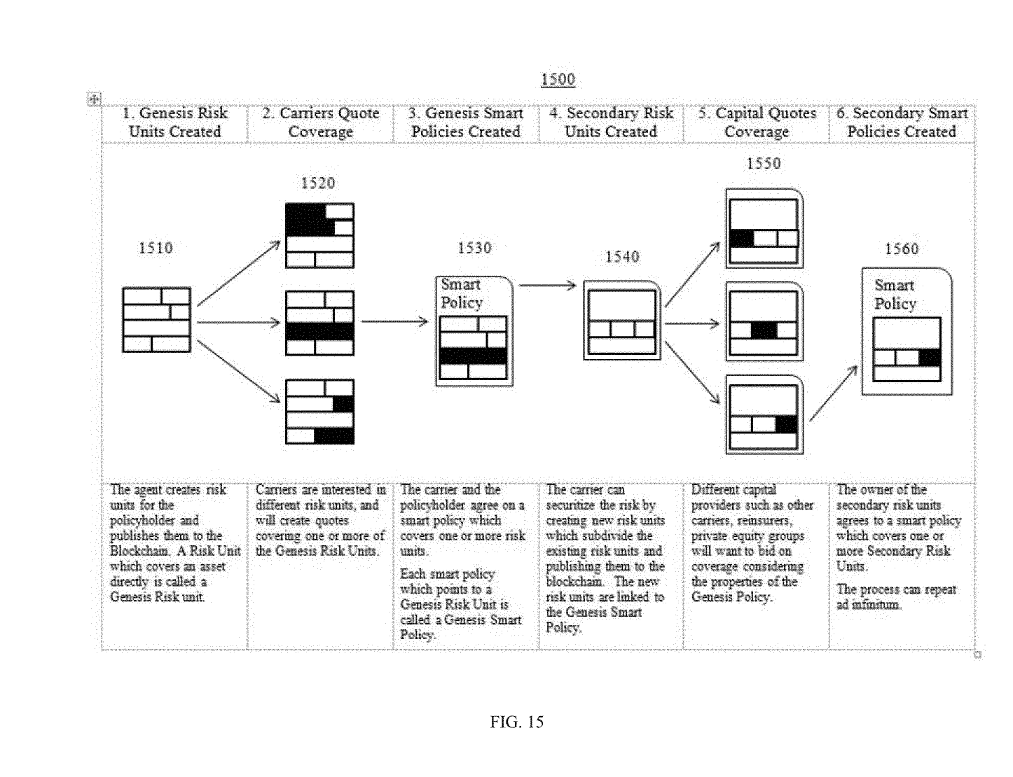

FIG. 15 illustrates an example of creating multiple smart policies in process 1500. In step 1510, an agent creates risk units for a policyholder and publishes the risk units to the blockchain. Here, a risk unit that covers an asset directly is labeled a genesis risk unit. In step 1520, carriers that are interested in different risk units create quotes covering one or more genesis risk units. The carrier and policyholder agree on a smart policy that covers one or more of the genesis (original) risk units in step 1530. Here, each smart policy that points to a genesis risk unit is labeled a genesis smart policy.

In step 1540, the carrier securitizes the risk by creating new risk units that subdivide the existing risk units in the genesis smart policy, and publishes the new risk units to the blockchain. The new risk units are linked to the genesis smart policy. In step 1550, capital providers (e.g., other carriers, reinsurers, private equity groups, etc.) bid on coverage based on the properties of the genesis smart policy. The owner of the new (e.g., secondary) risk units agrees on a smart policy that covers one or more new secondary risk units in step 1560. Process 1500 may continuously repeat, repeat at designated intervals, and repeat based on new triggering information, for example. Risk units may be infinitely divisible using many, effectively nested, smart policies.

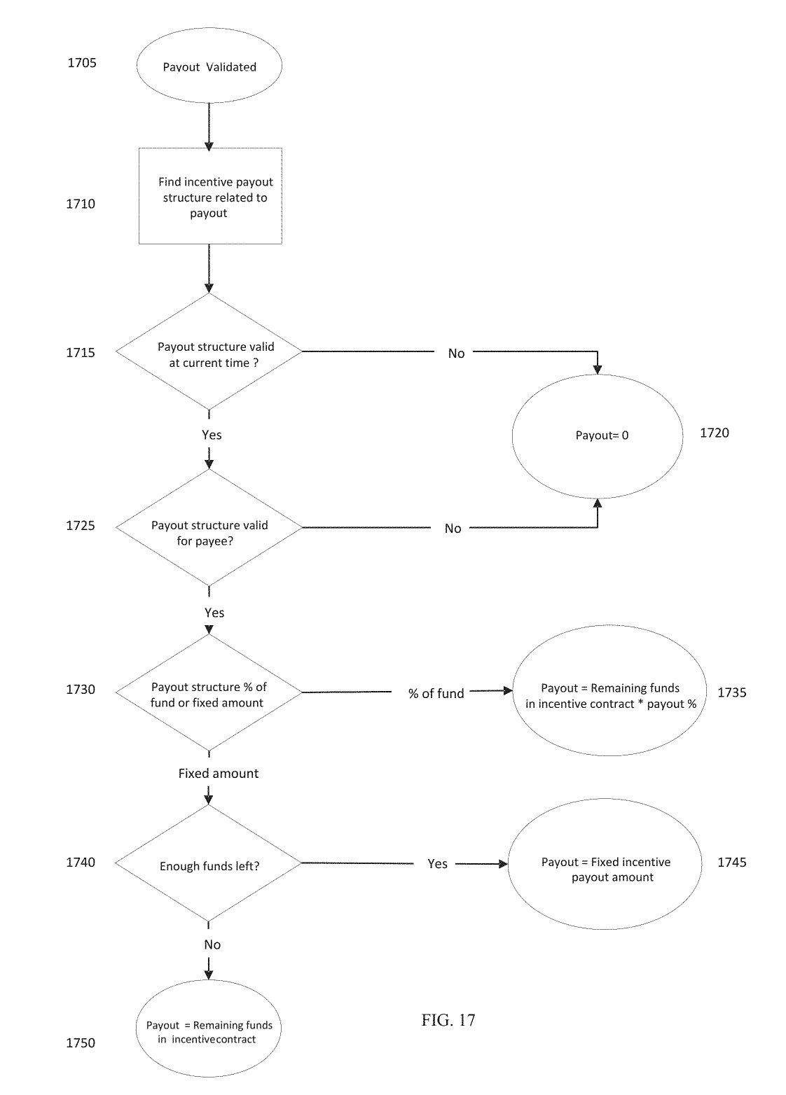

FIG. 17 illustrates an example of validating and paying a payout in process 1700. In step 1705 a payout is validated. The system then determines an incentive payout structure related to the payout in step 1710. In step 1715, it is determined if the payout structure is valid at the current time. If no, the payout is set to zero in step 1720. If yes, in step 1725 it is determined if the payout structure is valid for the intended payee. If no, the payout is set to zero in step 1720. If yes, it is determined in step 1730 if the payout structure is a percentage of a payout fund or a fixed amount. If the payout is to be a percentage of the payout fund, the payout is set to the remaining funds in the incentive contract times the payout percentage in step 1735. In step 1740, if the payout is to be a fixed amount, it is determined if there are sufficient funds left to cover the fixed amount. If yes, the payout is set to the fixed incentive payout amount in step 1745. If no, the payout is set to the remaining funds in the incentive contract in step 1750.

Examples will now be described using the example processes 1200-1500 of FIGS. 12-15, a client 110 that has a smartphone having an output device 214 that is a flat panel display, an input device 216 that is a touch screen interface, a content item database 224 that stores content that can be displayed on the smartphone, and a communications module 218 that provides for communication between the smartphone client 110 and a network 150 of servers 130, with at least one server 130 having an insurance content database 234 and an automated insurance provisioning application 236. The automated insurance provisioning application 236 may typically utilize a virtual machine operating on a blockchain. Alternately, it may utilize a parallel processors in server 130, processors of multiple servers 130 and/or clients 110 over network 150, or a combination of both.

In one example, the process begins when the automated insurance provisioning application 236 on a server 130 identifies an asset at risk. The asset information is stored in the insurance content database 234 or on a blockchain. The automated insurance provisioning application 236 then determines if there are one or more underlying risk unit(s) associated with the asset. If there are, those risk unit(s) may or may not be covered by an existing smart policy.

Continuing the example, the automated insurance provisioning application 236 consults the database, a trained recommender model, or accepts user input to determine which perils are relevant to the asset. For each peril it can use a database lookup table, a linear regression model, or user input to quantify the total risk exposure for the asset for that peril. It then determines the risk units to create by creating one or more risk layers with upper and lower bounds, percentage of each layer, and start/stop times to be associated with the asset. These risk layers and unit parameters may be automated by using organization or user preferences or an actuarial model. It may then publish the created risk units to a blockchain.

If the automated insurance provisioning application 236 determines that the asset is a risk unit already covered by a smart contract, the automated insurance provisioning application 236 determines if a new risk is junior or senior to the underlying risk unit, determines a risk layer associated with the asset with specified upper and lower coverage limits restricted to bounds of the underlying risk unit, defines a start time and a stop time associated with the asset and restricted to bounds of the underlying risk unit, determines a new risk unit associated with the asset, and publishes the new risk unit to the blockchain. The published risk unit/new risk unit is stored in the insurance content database 234 and may be provided to the client 110 via an application running on a smartphone over the network 150.

In another example, a participant in an insurance system or etwork may receive incentivean payout based on a smart contract on the system.

Here, the process begins when the automated insurance provisioning application 236 on a server 130 is notified by an outside party of a behavior event associated with the smart contract. The smart contract is stored in the insurance content database 234 or on a blockchain and periodically scans the system or network for a payout request. In either case, the automated insurance provisioning application 236 receives a payout notification, retrieves behavior data stored on the blockchain, determines if a payout is valid (e.g., using incentive contract logic).

Continuing the example, if the payout is determined to be valid, the automated insurance provisioning application 236 calculates the payout amount and sends the payout to the appropriate participant from a payout fund stored in the insurance content database 234. If, on the other hand, the payout is determined to not be valid, the automated insurance provisioning application 236 determines whether the smart contract allows for retries. If no retries are allowed, the automated insurance provisioning application 236 returns the payout funds to the creator of the smart contract. If retries are allowed, no funds are moved and the automated insurance provisioning application 236 starts the process over as a retry.

In yet another example of the subject technology, an example of using smart contract incentive logic to determine if a payout is valid is described.

Here, the automated insurance provisioning application 236 starts behavior evaluation upon retrieving behavior data from the blockchain or stored in the insurance content database 234. After validating that the smart contract is active, the automated insurance provisioning application 236 determines if the requested payee is eligible to receive a payment. If not, the behavior validation is determined to have failed and the payout is invalidated. However, if the requested payee is eligible to receive a payment, the automated insurance provisioning application 236 evaluates behavior rules using behavior data from the blockchain that is between valid start/stop times associated with the behavior rule, and determines if the behavior is one that is required to be present or required to not be present.

After one or more behaviors are found to be present (e.g., evaluates to TRUE), the automated insurance provisioning application 236 determines if the behavior rule evaluations meet the logic requirements of the complex behavior. If yes, the automated insurance provisioning application 236 validates the payout. If no, the automated insurance provisioning application 236 invalidates the payout.

In a further example, one or more smart policies are created by the system.

Here, a system participant (e.g., an agent) creates risk units for another system participant (e.g., a policyholder) via one or more servers 130 and/or clients 110. The risk units are stored in the insurance content database 234 or on the blockchain. If a created risk unit directly covers an asset, the risk unit is labeled a genesis risk unit. Yet another system participant (e.g., a carrier) creates a quote covering one or more genesis risk units. Via the system, the carrier and the policyholder agree on a smart contract that covers one or more risk units. Again, if the smart policy points to at least one genesis risk unit, it is labeled a genesis smart policy.

Using the automated insurance provisioning application 236, the carrier subdivides the existing risk units and publishes the subdivided risk units to be stored on the blockchain or in the insurance content database 234. Here, the subdivided risk units are linked back to the existing risk units within the insurance content database 234. A further participant (e.g., a capital provider) generates a bid on coverage based on properties of the genesis smart policy. Using the automated insurance provisioning application 236, the owner of the subdivided risk units generates a secondary smart policy that covers the subdivided risk units. The secondary smart policy is stored in the insurance content database 234.

The subject technology improves the performance of the server system and the network. For example, risk units may be continuously generated by the system and stored on a blockchain or to the database, thus increasing the efficiency of transactions associated with participants in the system. As another example, smart contracts are stored on a blockchain and automatically monitor the system for behaviors and payout information, thus eliminating laborious calculations by participant systems. Further, the subject technology makes many of the processes discussed above possible at all, as those processes cannot be performed by any combination of human labor, calculators, pen and paper and disconnected proprietary systems. For example, it would be incredibly labor intensive for a human underwriter to evaluate and price a single unit or risk using traditional manual methods. By publishing this data in a machine-accessible format algorithms and models can process large volumes of risk units at very high speeds. This allows risk to be more liquid and allows for new types of insurance products such as on-demand coverage.

### Hardware Overview

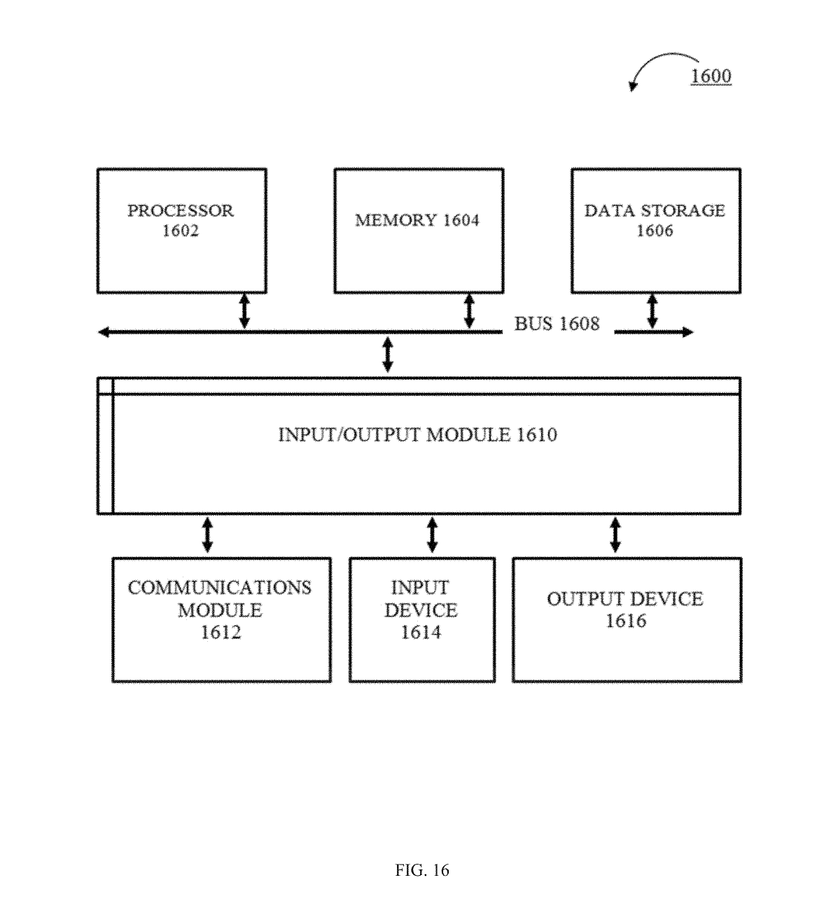

FIG. 16 is a block diagram illustrating an example computer system 1600 with which the client 110 and server 130 of FIG. 2 can be implemented. In certain aspects, the computer system 1600 may be implemented using hardware or a combination of software and hardware, either in a dedicated server or integrated into another entity or distributed across multiple entities.

Computer system 1600 (e.g., client 110 or server 130) includes a bus 1608 or other communication mechanism for communicating information, and a processor 1602 (e.g., processor 212 and 236) coupled with bus 1608 for processing information. According to one aspect, the computer system 1600 is implemented as one or more special-purpose computing devices. The special-purpose computing device may be hard-wired to perform the disclosed techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques. By way of example, the computer system 1600 may be implemented with one or more processors 1602. Processor 1602 may be a general-purpose microprocessor, a microcontroller, a Digital Signal Processor (DSP), an ASIC, a FPGA, a Programmable Logic Device (PLD), a controller, a state machine, gated logic, discrete hardware components, or any other suitable entity that can perform calculations or other manipulations of information.

Computer system 1600 can include, in addition to hardware, code that creates an execution environment for the computer program in question, e.g., code that constitutes processor firmware, a protocol stack, a database management system, an operating system, or a combination of one or more of them stored in an included memory 1604 (e.g., memory 220 and 230), such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 1608 for storing information and instructions to be executed by processor 1602. The processor 1602 and the memory 1604 can be supplemented by, or incorporated in, special purpose logic circuitry. Expansion memory may also be provided and connected to computer system 1600 through input/output module 1610, which may include, for example, a SIMM (Single in Line Memory Module) card interface. Such expansion memory may provide extra storage space for computer system 1600 or may also store applications or other information for computer system 1600. Specifically, expansion memory may include instructions to carry out or supplement the processes described above and may include secure information also. Thus, for example, expansion memory may be provided as a security module for computer system 1600 and may be programmed with instructions that permit secure use of computer system 1600. In addition, secure applications may be provided via the SIMM cards, along with additional information, such as placing identifying information on the SIMM card in a non-hackable manner.

The instructions may be stored in the memory 1604 and implemented in one or more computer program products, i.e., one or more modules of computer program instructions encoded on a computer readable medium for execution by, or to control the operation of, the computer system 1600, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, embeddable languages, and xml-based languages. Memory 1604 may also be used for storing temporary variable or other intermediate information during execution of instructions to be executed by processor 1602.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 1600 further includes a data storage device 1606 such as a magnetic disk or optical disk, coupled to bus 1608 for storing information and instructions. Computer system 1600 may be coupled via input/output module 1610 to various devices. The input/output module 1610 can be any input/output module. Example input/output modules 1610 include data ports such as USB ports. In addition, input/output module 1610 may be provided in communication with processor 1602, so as to enable near area communication of computer system 1600 with other devices. The input/output module 1610 may provide, for example, for wired communication in some implementations, or for wireless communication in other implementations, and multiple interfaces may also be used. The input/output module 1610 is configured to connect to a communications module 1612. Example communications modules 1612 (e.g., communications modules 218 and 238) include networking interface cards, such as Ethernet cards and modems.

The components of the system can be interconnected by any form or medium of digital data communication, e.g., a communication network. The communication network (e.g., network 150) can include, for example, any one or more of a PAN, a LAN, a CAN, a MAN, a WAN, a BBN, the Internet, and the like. Further, the communication network can include, but is not limited to, for example, any one or more of the following network topologies, including a bus network, a star network, a ring network, a mesh network, a star-bus network, tree or hierarchical network, or the like.

For example, in certain aspects, communications module 1612 can provide a two-way data communication coupling to a network link that is connected to a local network. Wireless links and wireless communication may also be implemented. Wireless communication may be provided under various modes or protocols, such as GSM (Global System for Mobile Communications), Short Message Service (SMS), Enhanced Messaging Service (EMS), or Multimedia Messaging Service (MMS) messaging, CDMA (Code Division Multiple Access), Time division multiple access (TDMA), Personal Digital Cellular (PDC), Wideband CDMA, General Packet Radio Service (GPRS), or LTE (Long-Term Evolution), among others. Such communication may occur, for example, through a radio-frequency transceiver. In addition, short-range communication may occur, such as using a BLUETOOTH, WI-FI, or other such transceiver.

In any such implementation, communications module 1612 sends and receives electrical, electromagnetic or optical signals that carry digital data streams representing various types of information. The network link typically provides data communication through one or more networks to other data devices. For example, the network link of the communications module 1612 may provide a connection through local network to a host computer or to data equipment operated by an Internet Service Provider (ISP). The ISP in turn provides data communication services through the world wide packet data communication network now commonly referred to as the Internet. The local network and Internet both use electrical, electromagnetic or optical signals that carry digital data streams. The signals through the various networks and the signals on the network link and through communications module 1612, which carry the digital data to and from computer system 1600, are example forms of transmission media.

Computer system 1600 can send messages and receive data, including program code, through the network(s), the network link and communications module 1612. In the Internet example, a server might transmit a requested code for an application program through Internet, the ISP, the local network and communications module 1612. The received code may be executed by processor 1602 as it is received, and/or stored in data storage 1606 for later execution.

In certain aspects, the input/output module 1610 is configured to connect to a plurality of devices, such as an input device 1614 (e.g., input device 216) and/or an output device 1616 (e.g., output device 214). Example input devices 1614 include a stylus, a finger, a keyboard and a pointing device, e.g., a mouse or a trackball, by which a user can provide input to the computer system 1600. Other kinds of input devices 1614 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback; and input from the user can be received in any form, including acoustic, speech, tactile, or brain wave input. Example output devices 1616 include display devices, such as a LED (light emitting diode), CRT (cathode ray tube), LCD (liquid crystal display) screen, a TFT LCD (Thin-Film-Transistor Liquid Crystal Display) or an OLED (Organic Light Emitting Diode) display, for displaying information to the user. The output device 1616 may comprise appropriate circuitry for driving the output device 1616 to present graphical and other information to a user.

According to one aspect of the present disclosure, the client 110 and server 130 can be implemented using a computer system 1600 in response to processor 1602 executing one or more sequences of one or more instructions contained in memory 1604. Such instructions may be read into memory 1604 from another machine-readable medium, such as data storage device 1606. Execution of the sequences of instructions contained in main memory 1604 causes processor 1602 to perform the process steps described herein. One or more processors in a multi-processing arrangement may also be employed to execute the sequences of instructions contained in memory 1604. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components.

Computing system 1600 can include clients and servers. A client and server are generally remote from each other and typically interact through a communication network. The relationship of client and server arises by virtue of computer programs running on the respective computers and having a client-server relationship to each other. Computer system 1600 can be, for example, and without limitation, a desktop computer, laptop computer, or tablet computer. Computer system 1600 can also be embedded in another device, for example, and without limitation, a mobile telephone, a personal digital assistant (PDA), a mobile audio player, a Global Positioning System (GPS) receiver, a video game console, and/or a television set top box.

The term “machine-readable storage medium” or “computer-readable medium” as used herein refers to any medium or media that participates in providing instructions or data to processor 1602 for execution. The term “storage medium” as used herein refers to any non-transitory media that store data and/or instructions that cause a machine to operate in a specific fashion. Such a medium may take many forms, including, but not limited to, non-volatile media, volatile media, and transmission media. Non-volatile media include, for example, optical disks, magnetic disks, or flash memory, such as data storage device 1606. Volatile media include dynamic memory, such as memory 1604. Transmission media include coaxial cables, copper wire, and fiber optics, including the wires that comprise bus 1608. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter affecting a machine-readable propagated signal, or a combination of one or more of them.

As used in this specification of this application, the terms “computer-readable storage medium” and “computer-readable media” are entirely restricted to tangible, physical objects that store information in a form that is readable by a computer. These terms exclude any wireless signals, wired download signals, and any other ephemeral signals. Storage media is distinct from but may be used in conjunction with transmission media. Transmission media participates in transferring information between storage media. For example, transmission media includes coaxial cables, copper wire and fiber optics, including the wires that comprise bus 1608. Transmission media can also take the form of acoustic or light waves, such as those generated during radio-wave and infra-red data communications. Furthermore, as used in this specification of this application, the terms “computer”, “server”, “processor”, and “memory” all refer to electronic or other technological devices. These terms exclude people or groups of people. For the purposes of the specification, the terms display or displaying means displaying on an electronic device.

In one aspect, a method may be an operation, an instruction, or a function and vice versa. In one aspect, a clause or a claim may be amended to include some or all of the words (e.g., instructions, operations, functions, or components) recited in either one or more clauses, one or more words, one or more sentences, one or more phrases, one or more paragraphs, and/or one or more claims.

In one or more aspects, a computer-implemented method is provided for creating and utilizing smart policies in a blockchain, the method including generating, via one or more processors, one or more risk units associated with an asset and publishing, by one or more processors, the one or more risk units to the blockchain. The method also includes creating, via one or more processors, a quote covering at least one of the one or more risk units and generating, by one or more processors, an agreement between a coverage seller and a policyholder on a smart policy that covers at least one of the one or more risk units. The method further includes subdividing, by the coverage seller via one or more processors, the one or more risk units into secondary risk units and publishing, by one or more processors, the secondary risk units to the blockchain. The method also includes generating, by one or more processors, an agreement by an owner of the secondary risk units to a smart contract that covers one or more of the secondary risk units. In one embodiment the processors are a virtual machine running on a blockchain. The method may also include systems with memory and processors connected to run a distributed virtual machine to run code written on a blockchain.

The method may also include any of wherein the secondary risk units are linked to the smart policy; generating, by one or more processors, a bid from a capital provider for coverage based on properties of the smart policy; wherein the capital provider is another carrier; wherein the capital provider is a reinsurer; and wherein the capital provider is a private equity group. The method may further include wherein the generating one or more risk units associated with the policyholder includes determining, by the one or more processors, a peril, a risk layer, a start time and a stop time, each associated with an asset of the policyholder, and determining, by the one or more processors, the one or more risk units based on the peril, the risk layer, the start time and the stop time. The method may also include any of wherein the risk layer includes specified upper and lower coverage limits, and wherein the one or more risk units are each defined as a percentage of the risk layer, appending provenance metadata to the secondary risk units, the provenance metadata tying the secondary risk units back to the one or more risk units associated with the policyholder, and wherein if the smart policy includes at least one condition associated with a behavior of the policyholder, monitoring the behavior of the policyholder and automatically revising at least one parameter of the smart policy if the monitoring indicates a change in a status of the behavior of the policyholder.

In one or more aspects, an interconnect policy system is provided, the system including a memory and a processor configured to execute instructions which, when executed, cause the processor to generate one or more risk units associated with an asset; publish the one or more risk units to a blockchain; create a quote covering at least one of the one or more risk units; generate an agreement between a coverage seller and a policyholder on a smart policy covering at least one of the one or more risk units; subdivide the one or more risk units into a plurality of secondary risk units; publish the plurality of secondary risk units to the blockchain; generate an agreement to a smart contract that covers one or more of the secondary risk units; and link the secondary risk units to the smart policy.

The system may also include wherein the instructions further cause the processor to generate a bid from a capital provider for coverage based on properties of the smart policy, generate a new smart contract between the capital provider and the carrier that owns the smart policy, and publish the new smart contract to the blockchain. The system may further include any of wherein the capital provider is one of another carrier, a reinsurer and a private equity fund, and wherein the risk layer includes specified upper and lower coverage limits, and the one or more risk units are each defined as a percentage of the risk layer. The system may also include instructions that cause the processor to identify one or more factors associated with an asset of the policyholder, the one or more factors comprising at least one of a peril, a risk layer, a start time and a stop time, and determine the one or more risk units based on the identified one or more factors. The system may further include instructions that cause the processor to append provenance metadata to the secondary risk units, the provenance metadata tying the secondary risk units back to the one or more risk units associated with the policyholder.

In one or more aspects, a non-transitory machine-readable storage medium having machine-readable instructions for causing a processor to execute a method for creating and utilizing smart policies in a blockchain is provided, the method including generating, by an agent, one or more risk units associated with an asset; publishing the one or more risk units to the blockchain; creating a quote covering at least one of the one or more risk units; generating an agreement between one of a coverage seller and a carrier, and the policyholder, to a smart policy covering at least one of the one or more risk units; subdividing the one or more risk units into secondary risk units; publishing the secondary risk units to the blockchain; linking the secondary risk units to the smart policy; and generating a smart contract covering one or more of the secondary risk units.

The method may also include determining a peril, a risk layer, a start time and a stop time, each associated with an asset of the policyholder, and generating the one or more risk units based on the peril, the risk layer, the start time and the stop time. The method may further include appending provenance metadata to the secondary risk units, the provenance metadata tying the secondary risk units back to the one or more risk units associated with the policyholder. The method may also include monitoring a behavior of the policyholder and automatically revising at least one parameter of the smart policy if the monitoring indicates a change in a status of the behavior of the policyholder.

In one or more aspects, a computer-implemented method for providing a risk unit to a blockchain, the method including identifying, by one or more processors, an asset at risk; determining, by the one or more sery processors ers, if the asset has an underlying risk unit in an existing smart policy, wherein if there is no underlying risk unit; quantifying, by the one or more processors, exposure of the asset by peril; selecting, by the one or more processors, a peril to be associated with the asset; determining, by the one or more sery processors ers, a risk layer associated with the asset; defining, by the one or more processors, a start time and a stop time associated with the asset; determining, by the one or more processors, a risk unit associated with the asset; and, publishing the risk unit to the blockchain.

The method may also include any of wherein the risk unit is defined as a percentage of the risk layer; wherein the risk layer comprises specified upper and lower coverage limits; wherein if there is an underlying risk unit in an existing smart contract, the method further includes determining, by the one or more processors, if a new risk is junior or senior to the underlying risk unit; the method further includes determining, by the one or more processors, a risk layer associated with the asset, wherein the risk layer comprises specified upper and lower coverage limits restricted to bounds of the underlying risk unit; the method further includes defining, by the one or more processors, a start time and a stop time associated with the asset and restricted to bounds of the underlying risk unit; the method further includes determining, by the one or more processors, a new risk unit associated with the asset; wherein the new risk unit is defined as a percentage of the underlying risk unit; the method further includes appending provenance metadata to the new risk unit, the provenance metadata tying the new risk unit back to the underlying risk unit of the existing smart policy; and the method further includes publishing the new risk unit to the blockchain.

In one or more aspects, a risk securitization system is provided, the system including a memory and a processor configured to execute instructions which, when executed, cause the processor to identify an asset at risk; determine if the asset has an underlying risk unit in an existing smart policy, wherein if there is an underlying risk unit; determine if a new risk is junior or senior to the underlying risk unit; determine a risk layer associated with the asset, wherein the risk layer comprises specified upper and lower coverage limits restricted to bounds of the underlying risk unit; define a start time and a stop time associated with the asset and restricted to bounds of the underlying risk unit; determine a new risk unit associated with the asset; and, publish the new risk unit to a blockchain.

The system may also include any of wherein the new risk unit is defined as a percentage of the underlying risk unit; further having instructions that cause the processor to append provenance metadata to the new risk unit, the provenance metadata tying the new risk unit back to the underlying risk unit of the existing smart policy; wherein if there is no underlying risk unit in an existing smart policy, further having instructions that cause the processor to quantify exposure of the asset by peril and select a peril to be associated with the asset; further having instructions that cause the processor to determine a risk layer associated with the asset, wherein the risk layer comprises specified upper and lower coverage limits and define a start time and a stop time associated with the asset; and further having instructions that cause the processor to determine a risk unit associated with the asset, wherein the risk unit is defined as a percentage of the risk layer and publish the risk unit to the blockchain.

In one or more aspects, a computer-implemented method for causing a processor to execute a method for providing a risk unit to a blockchain is provided, the method including identifying, by one or more processors, an asset at risk; determining, by the one or more processors, if the asset has an underlying risk unit in an existing smart policy; wherein if there is no underlying risk unit: quantifying, by the one or more processors, exposure of the asset by peril; selecting, by the one or more processors, a peril to be associated with the asset; determining, by the one or more processors, a risk layer associated with the asset; defining, by the one or more processors, a start time and a stop time associated with the asset; determining, by the one or more processors, a risk unit associated with the asset; and publishing the risk unit to the blockchain; wherein if there is an underlying risk unit: determining if a new risk is junior or senior to the underlying risk unit; determining a risk layer associated with the asset, wherein the risk layer comprises specified upper and lower coverage limits restricted to bounds of the underlying risk unit; defining a start time and a stop time associated with the asset and restricted to bounds of the underlying risk unit; determining a new risk unit associated with the asset; and, publishing the new risk unit to the blockchain.

The method may also include any of appending provenance metadata to the new risk unit, the provenance metadata tying the new risk unit back to the underlying risk unit of the existing smart policy; wherein the risk unit is defined as a percentage of the risk layer; and wherein the new risk unit is defined as a percentage of the underlying risk unit.

In one or more aspects, a computer-implemented method is provided for executing a smart contract in a blockchain, the method including receiving, by one or more processors, a payout notification, wherein the payout notification is generated by one of a notification to the smart contract of a behavior event and the smart contract periodically scanning for a payout request; retrieving, by one or more processors, behavior data from the blockchain; determining, by one or more processors, if a payout is valid based on smart contract logic; wherein if the payout is valid: calculating, by one or more processors, a payout amount; and generating, by one or more processors, a payout from a payout fund; and wherein if the payout is not valid: returning payout funds to a creator of the smart contract if the smart contract does not allow for retrying the payout process; and holding the payout funds if the smart contract allows for retrying the payout process.

The method may also include any of wherein the determining if a payout is valid includes initiating a behavior evaluation and validating the smart contract is active; determining a requested payee is not eligible to receive a payment, indicating that the behavior evaluation failed, and invalidating the payout; determining a requested payee is eligible to receive a payment, evaluating a complex behavior, determining if there is a child behavior associated with the complex behavior, and evaluating the child behavior; determining there are no remaining child behaviors of the complex behavior to evaluate and evaluating a behavior rule defined for the complex behavior; determining valid start and end times defined by the behavior rule and evaluating behavior data from the blockchain that falls between the valid start and end times; determining if a behavior associated with the behavior rule should be present or not present for the behavior rule to be satisfied, setting the behavior rule as not satisfied if the behavior is required to be present and the behavior is not present, and setting the behavior rule as not satisfied if the behavior is required to not be present and the behavior is present; determining a behavior associated with the behavior rule should be present and is present or should not be present and is not present, determining that one of a specific person, a specific organization and a specific asset is supposed to generate the behavior, and setting the behavior rule as not satisfied if the one of the specific person, the specific organization and the specific asset did not generate the behavior; determining a behavior associated with the behavior rule should be present and is present or should not be present and is not present, determining if one of a specific person, a specific organization and a specific asset is supposed to generate the behavior, setting the behavior rule as satisfied if the one of the specific person, the specific organization and the specific asset is supposed to generate the behavior and did generate the behavior, and setting the behavior rule as satisfied if no specific person, organization or asset is supposed to generate the behavior; evaluating each remaining behavior rule defined for the complex behavior and determining whether each behavior rule evaluation meets logic requirements of the complex behavior; validating the payout if all of the behavior rule evaluations meet the logic requirements of the complex behavior; and wherein if one of the behavior rule evaluations fails to meet the logic requirements of the complex behavior, the method further includes indicating the behavior evaluation failed and invalidating the payout.

In one or more aspects, a smart contract system is provided, the system including a memory and a processor configured to execute instructions which, when executed, cause the processor to scan the system periodically, by a smart contract, for a payout request; receive a payout notification; retrieve behavior data from a blockchain; determine if a payout is valid based on smart contract logic; wherein if the payout is valid: calculate a payout amount; and generate a payout from a payout fund; and wherein if the payout is not valid: return payout funds to a creator of the smart contract if the smart contract does not allow for retrying the payout process; and hold the payout funds if the smart contract allows for retrying the payout process.

The system may also include wherein the determining if a payout is valid further includes instructions that cause the processor to initiate a behavior evaluation; validate the smart contract is active; determine if a requested payee is eligible to receive a payment; indicate the behavior evaluation failed and invalidate the payout if the requested payee is not eligible to receive a payment; and evaluate a complex behavior if the requested payee is eligible to receive a payment. The system may further include instructions that cause the processor to: determine if there are any child behavior associated with the complex behavior; evaluate all child behaviors; evaluate a behavior rule defined for the complex behavior; determine valid start and end times defined by the behavior rule; evaluate behavior data from the blockchain that falls between the valid start and end times; and determine if a behavior associated with the behavior rule should be present or not present for the behavior rule to be satisfied. The system may also include instructions that cause the processor to set the behavior rule as not satisfied if any of the behavior is required to be present and the behavior is not present, the behavior is required to not be present and the behavior is present, and one of a specific person, a specific organization and a specific asset is supposed to generate the behavior and does not. The system may further include instructions that cause the processor to: determine a behavior associated with the behavior rule should be present and is present or should not be present and is not present; set the behavior rule as satisfied if the one of the specific person, the specific organization and the specific asset is supposed to generate the behavior and did generate the behavior or if no specific person, organization or asset is supposed to generate the behavior; evaluate each remaining behavior rule defined for the complex behavior; determine whether each behavior rule evaluation meets logic requirements of the complex behavior; and validate the payout if all of the behavior rule evaluations meet the logic requirements of the complex behavior.

In one or more aspects, a non-transitory machine-readable storage medium having machine-readable instructions for causing a processor to execute a method for executing a smart contract in a blockchain is provided, the method including scanning periodically, by the smart contract in the blockchain, for a payout request; receiving a payout notification based on the payout request; retrieving, by one or more processors, behavior data from the blockchain; determining, by one or more processors, if a payout is valid based on smart contract logic; wherein if the payout is valid: calculating, by one or more processors, a payout amount; and generating, by one or more processors, a payout from a payout fund; and wherein if the payout is not valid: returning payout funds to a creator of the smart contract if the smart contract does not allow for retrying the payout process; and holding the payout funds if the smart contract allows for retrying the payout process.

The method may also include wherein the determining if a payout is valid includes initiating a behavior evaluation; validating the smart contract is active; determining if a requested payee is eligible to receive a payment; if the requested payee is not eligible to receive a payment: indicating that the behavior evaluation failed; and invalidating the payout; if the requested payee is eligible to receive a payment: evaluating a complex behavior; evaluating any child behaviors associated with the complex behavior; evaluating a behavior rule defined for the complex behavior; determining valid start and end times defined by the behavior rule; and evaluating behavior data from the blockchain that falls between the valid start and end times. The method may further include determining if a behavior associated with the behavior rule should be present or not present for the behavior rule to be satisfied; setting the behavior rule as not satisfied if any of the behavior is required to be present and the behavior is not present, the behavior is required to not be present and the behavior is present, and one of a specific person, a specific organization and a specific asset is supposed to generate the behavior and does not; if the one of the specific person, the specific organization and the specific asset is supposed to generate the behavior and did generate the behavior or if no specific person, organization or asset is supposed to generate the behavior: setting the behavior rule as satisfied; evaluating each remaining behavior rule defined for the complex behavior; determining whether each behavior rule evaluation meets logic requirements of the complex behavior; and validating the payout if all of the behavior rule evaluations meet the logic requirements of the complex behavior.

To illustrate the interchangeability of hardware and software, items such as the various illustrative blocks, modules, components, methods, operations, instructions, and algorithms have been described generally in terms of their functionality. Whether such functionality is implemented as hardware, software or a combination of hardware and software depends upon the particular application and design constraints imposed on the overall system. Skilled artisans may implement the described functionality in varying ways for each particular application.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the term “include,” “have,” or the like is used in the description or the claims, such term is intended to be inclusive in a manner similar to the term “comprise” as “comprise” is interpreted when employed as a transitional word in a claim. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for.”

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A computer-implemented method for executing a smart contract in a blockchain, the method comprising:
receiving, by one or more processors, a payout notification, wherein the payout notification is generated by one of a notification to the smart contract of a behavior event and the smart contract periodically scanning for a payout request;
retrieving, by one or more processors, behavior data from the blockchain;
determining, by one or more processors, if a payout is valid based on smart contract logic;
wherein if the payout is valid:
calculating, by one or more processors, a payout amount; and
generating, by one or more processors, a payout from a payout fund; and
wherein if the payout is not valid:
returning payout funds to a creator of the smart contract if the smart contract does not allow for retrying the payout process; and
holding the payout funds if the smart contract allows for retrying the payout process.

2. The method of claim 1, wherein the determining if a payout is valid comprises:
initiating a behavior evaluation; and
validating the smart contract is active.

3. The method of claim 2, further comprising:
determining a requested payee is not eligible to receive a payment;
indicating that the behavior evaluation failed; and
invalidating the payout.

4. The method of claim 2, further comprising:
determining a requested payee is eligible to receive a payment;
evaluating a complex behavior;
determining if there is a child behavior associated with the complex behavior; and
evaluating the child behavior.

5. The method of claim 4, further comprising:
determining there are no remaining child behaviors of the complex behavior to evaluate; and
evaluating a behavior rule defined for the complex behavior.

6. The method of claim 5, further comprising:
determining valid start and end times defined by the behavior rule;
evaluating behavior data from the blockchain that falls between the valid start and end times.

7. The method of claim 6, further comprising:
determining if a behavior associated with the behavior rule should be present or not present for the behavior rule to be satisfied;
setting the behavior rule as not satisfied if the behavior is required to be present and the behavior is not present; and
setting the behavior rule as not satisfied if the behavior is required to not be present and the behavior is present.

8. The method of claim 6, further comprising:
determining a behavior associated with the behavior rule should be present and is present or should not be present and is not present;
determining that one of a specific person, a specific organization and a specific asset is supposed to generate the behavior; and
setting the behavior rule as not satisfied if the one of the specific person, the specific organization and the specific asset did not generate the behavior.

9. The method of claim 6, further comprising:
determining a behavior associated with the behavior rule should be present and is present or should not be present and is not present;
determining if one of a specific person, a specific organization and a specific asset is supposed to generate the behavior;
setting the behavior rule as satisfied if the one of the specific person, the specific organization and the specific asset is supposed to generate the behavior and did generate the behavior; and
setting the behavior rule as satisfied if no specific person, organization or asset is supposed to generate the behavior.

10. The method of claim 9, further comprising:
evaluating each remaining behavior rule defined for the complex behavior;
determining whether each behavior rule evaluation meets logic requirements of the complex behavior; and validating the payout if all of the behavior rule evaluations meet the logic requirements of the complex behavior.

11. The method of claim 9, wherein if one of the behavior rule evaluations fails to meet the logic requirements of the complex behavior, the method further comprising:
indicating the behavior evaluation failed; and
invalidating the payout.

12. The method of claim 1, wherein the processors are virtual machines that run code written to the blockchain.

13. A smart contract system, the system comprising:
a memory; and
a processor configured to execute instructions which, when executed, cause the processor to:
scan the system periodically, by a smart contract, for a payout request;
receive a payout notification;
retrieve behavior data from a blockchain;
determine if a payout is valid based on smart contract logic;
wherein if the payout is valid:
calculate a payout amount; and
generate a payout from a payout fund; and
wherein if the payout is not valid:
return payout funds to a creator of the smart contract if the smart contract does not allow for retrying the payout process; and
hold the payout funds if the smart contract allows for retrying the payout process.

14. The system of claim 13, wherein the determining if a payout is valid further comprises instructions that cause the processor to:
initiate a behavior evaluation;
validate the smart contract is active;
determine if a requested payee is eligible to receive a payment;
indicate the behavior evaluation failed and invalidate the payout if the requested payee is not eligible to receive a payment; and
evaluate a complex behavior if the requested payee is eligible to receive a payment.

15. The system of claim 14, further comprising instructions that cause the processor to:
determine if there are any child behavior associated with the complex behavior;
evaluate all child behaviors;
evaluate a behavior rule defined for the complex behavior;
determine valid start and end times defined by the behavior rule;
evaluate behavior data from the blockchain that falls between the valid start and end times; and
determine if a behavior associated with the behavior rule should be present or not present for the behavior rule to be satisfied.

16. The system of claim 15, further comprising instructions that cause the processor to:
set the behavior rule as not satisfied if any of the behavior is required to be present and the behavior is not present, the behavior is required to not be present and the behavior is present, and one of a specific person, a specific organization and a specific asset is supposed to generate the behavior and does not.

17. The system of claim 15, further comprising instructions that cause the processor to:
determine a behavior associated with the behavior rule should be present and is present or should not be present and is not present;
set the behavior rule as satisfied if the one of the specific person, the specific organization and the specific asset is supposed to generate the behavior and did generate the behavior or if no specific person, organization or asset is supposed to generate the behavior;
evaluate each remaining behavior rule defined for the complex behavior;
determine whether each behavior rule evaluation meets logic requirements of the complex behavior; and
validate the payout if all of the behavior rule evaluations meet the logic requirements of the complex behavior.

18. A non-transitory machine-readable storage medium comprising machine-readable instructions for causing a processor to execute a method for executing a smart contract in a blockchain, the method comprising:
scanning periodically, by the smart contract in the blockchain, for a payout request;
receiving a payout notification based on the payout request;
retrieving, by one or more servers, behavior data from the blockchain;
determining, by one or more servers, if a payout is valid based on smart contract logic;
wherein if the payout is valid:
calculating, by one or more servers, a payout amount; and
generating, by one or more servers, a payout from a payout fund; and
wherein if the payout is not valid:
returning payout funds to a creator of the smart contract if the smart contract does not allow for retrying the payout process; and
holding the payout funds if the smart contract allows for retrying the payout process.

19. The non-transitory machine-readable storage medium of claim 18, wherein the determining if a payout is valid comprises:
initiating a behavior evaluation;
validating the smart contract is active;
determining if a requested payee is eligible to receive a payment;
if the requested payee is not eligible to receive a payment:
indicating that the behavior evaluation failed; and
invalidating the payout;
if the requested payee is eligible to receive a payment:
evaluating a complex behavior;
evaluating any child behaviors associated with the complex behavior;
evaluating a behavior rule defined for the complex behavior;
determining valid start and end times defined by the behavior rule; and
evaluating behavior data from the blockchain that falls between the valid start and end times.

20. The non-transitory machine-readable storage medium of claim 19, the method further comprising:
determining if a behavior associated with the behavior rule should be present or not present for the behavior rule to be satisfied;
setting the behavior rule as not satisfied if any of the behavior is required to be present and the behavior is not present, the behavior is required to not be present and the behavior is present, and one of a specific person, a specific organization and a specific asset is supposed to generate the behavior and does not;
if the one of the specific person, the specific organization and the specific asset is supposed to generate the behavior and did generate the behavior or if no specific person, organization or asset is supposed to generate the behavior:
setting the behavior rule as satisfied;
evaluating each remaining behavior rule defined for the complex behavior;
determining whether each behavior rule evaluation meets logic requirements of the complex behavior; and
validating the payout if all of the behavior rule evaluations meet the logic requirements of the complex behavior.
